(19) United States
(12) Patent Application Publication
(10) Pub. No.: US 2026/0098974 A1
(43) Pub. Date: Apr. 9, 2026

(54) NANOPHOTONIC PURCELL ENHANCED METAMATERIAL SCINTILLATOR

(71) Applicant: THE BOARD OF TRUSTEES OF THE LELAND STANFORD JUNIOR UNIVERSITY, Stanford, CA (US)

(72) Inventors: Parivash MORADIFAR, Menlo Park, CA (US); Garry CHINN, San Mateo, CA (US); Craig S. LEVIN, Palo Alto, CA (US); Jennifer A. DIONNE, Menlo Park, CA (US); Yushin KIM, Palo Alto, CA (US)

(21) Appl. No.: 19/114,292

(22) PCT Filed: Sep. 21, 2023
(86) PCT No.: PCT/US2023/074803

§ 371 Date: Mar. 21, 2025

Related U.S. Application Data
(60) Provisional application No. 63/376,561, filed on Sep. 21, 2022.

(51) Int. Cl. G01T 1/202; B33Y 80/00; B82Y 20/00; C09K 11/77

(52) U.S. Cl. CPC G01T 1/2023; B33Y 80/00; C09K 11/7773; B82Y 20/00

(57) ABSTRACT

A Purcell enhanced metamaterial scintillator structure comprises a conducting structure and a dielectric structure disposed adjacent to the conducting structure. The dielectric structure comprises a structure of scintillating nanoparticles.

### CROSS-REFERENCE TO RELATED APPLICATIONS

This application claims priority to and benefit of U.S. Provisional Patent Application Ser. No. 63/376,561, filed Sep. 21, 2022, which application is incorporated in its entirety herein by reference.

### FEDERALLY SPONSORED RESEARCH OR DEVELOPMENT

This invention was made with Government support under contract T32 CA118681 (TRAINING) awarded by the National Institutes of Health. The Government has certain rights in the invention.

### FIELD

This disclosure relates generally to materials, devices, and systems for medical imaging, and methods for fabricating materials and devices. Embodiments of the invention relate more particularly to materials, devices, and systems for Positron Emission Tomography (PET).

### BACKGROUND

Precision health and early cancer detection refers to identifying cancer in its earliest stages when it is small and has not spread to other organs and in particular the patient is not experiencing symptoms yet. Over the last few decades, many different revolutionary pathways have been proposed and pursued to detect and predict cancer from innovative non-invasive diagnostic tools such as liquid biopsy to predicting DNA mutations using Al based DNA analysis and developing new hardware in medical imaging diagnosis. In particular, diagnostic imaging modalities play a critical role in monitoring disease onset and progression.

Positron emission tomography (PET) is a diagnostic imaging modality that is commonly used to non-invasively visualize and quantify the molecular pathways of disease such as but not limited to cancer, neurological diseases, cardiovascular diseases, and others for detection, staging, and guiding/monitoring treatment, and is also widely employed for biology research. A PET study involves collecting millions of pairs of annihilation photon pairs, which are, oppositely-directed, high energy radiation with energy of 511 keV that are simultaneously emitted (coincident) after annihilation between emitted positrons from a positron-emitting radionuclide-labeled contrast agent injected into a patient and the electrons inside the patient's body. The position, energy, and arrival time of the 511 keV photons are detected by the PET system, e.g., in a detector ring surrounding the patient, and used to “reconstruct” a 3-D image of the tracer biodistribution, e.g., for evaluating disease.

Scintillation is the spontaneous emission under the excitation of electrons via ionizing radiation (into higher energy states) and subsequent radiative decay of excited electrons back to their ground states. Scintillators are materials that convert high-energy radiation into a large number of low energy photons in the near UV (NUV)—visible (Vis) range of the spectrum. Scintillating crystals are used in a variety of applications spanning from diagnostic medical imaging such as PET, nuclear detection, environmental monitoring, and security cameras to high-energy physics and astrophysics. Several different types of organic and inorganic scintillators ranging from plastic scintillators to ionic solids and ceramics have been developed, among which ionic solids and high-density crystals are among the most common commercial scintillators.

PET systems use scintillators to convert 511 keV annihilation photons into visible light. The cascade process of free charge carriers created by 511 keV annihilation photon interactions leads to the generation of photons in the in scintillators. As shown in FIG. 1, for instance, a scintillator 10 of a typically organic scintillator material converts high-energy radiation (shown as ionizing radiation) 12 into low energy photons 14 in UV visible (UV-Vis) region. These low energy photons 14 are detectable by a light sensor 16.

Most commercial PET systems have very low efficiency (˜1-2%) for detecting 511 keV photon pairs, resulting in noisy images due to poor reconstructed image signal-to-noise ratio (SNR or RISNR). The RISNR can be improved by time-of-flight (ToF) positron emission tomography (ToF-PET), where the measured arrival time difference of coincidence photons is used to localize the annihilation event location along system response lines (LOR) during image reconstruction. The more precise the measured time difference, known as the coincidence time resolution (CTR), the better the RISNR.

To enhance PET capabilities for applications such as but not limited to lesion detection and quantification for earlier detection of primary and metastatic malignant lesions, it is desirable to improve CTR. Providing better CTR, for instance, can provide substantially better image resolution and lesion detection, and/or allow for much lower injected radiation dose or study duration.

For PET imaging an ultrafast scintillator is crucial for improving coincidence timing. An ultrafast scintillator can improve the coincidence time window and temporal resolution, thereby reducing statistical uncertainty in positioning (e.g., smaller error in x-y-z coordinates) and allowing for better localization and detection sensitivity. The temporal variation of the scintillation photon detection is mainly dependent on the brightness, rise time, and decay time of the scintillator.

However, the limited luminescence emission rate and yield of scintillator materials is a limiting factor in PET CTR.

### SUMMARY

According to one aspect of the disclosed embodiments, a Purcell enhanced metamaterial scintillator structure is provided comprising: a conducting or plasmonic structure (generally, conducting structure); and a dielectric structure disposed adjacent to the conducting structure. The dielectric structure comprises a structure of scintillating nanoparticles.

According to another aspect, a detector of emitted photons comprises a Purcell enhanced metamaterial scintillator structure according to the above; and a photosensor configured to receive scintillation light from the Purcell enhanced metamaterial scintillator structure in response to the Purcell enhanced metamaterial scintillator structure creating luminescence photons and to generate timing and energy signals in response.

According to another aspect, an imaging system comprises a plurality of detectors according to the above; processing electronics configured to receive generated timing and energy signals from a pair of the detectors; and a processor configured to generate an image by processing the generated signals. Example processing electronics include, but are not limited to a field programmable gate array (FPGA), an application specific integrated circuit (ASIC), or others. Example processors include, but are not limited to, computer processors, which computer processors may operate with a memory.

According to another aspect, a method for forming a Purcell enhanced metamaterial scintillator structure comprises: fabricating scintillating nanoparticles from a material having a chemical structure of, for example, MₓLn_{y}F_{z} with M being Li, Na, Ca, Sr, or Ba and Ln being trivalent rare-earth ions; and forming a conducting structure and a dielectric structure disposed adjacent to the conducting structure, wherein the dielectric structure comprises a thin film of the scintillating nanoparticles. In some embodiments the conducting structure and/or the dielectric structure may each be subwavelength (wavelength of the luminescence) in thickness, while in other embodiments the conducting structure and/or the dielectric structure may have a thickness greater than subwavelength.

### DESCRIPTION OF THE DRAWINGS

The drawings set forth herein are illustrative of exemplary embodiments provided herein and are not meant to limit the scope of the invention as encompassed by the claims.

The present disclosure will become more fully understood from the detailed description and the accompanying drawings, wherein:

FIG. 1 shows a schematic of a scintillating crystal as a material for converting high-energy radiation into a large number of low energy photons in UV-Vis region.

FIG. 2 illustrates common bulk scintillators with emission wavelengths spanning from ˜200-600 nm and decay constant varying between subnanosecond (0.6 ns) to ˜1000 ns.

FIG. 3 shows: (a) an FCC structure of an example MLnF core-shell nanoscintillator; (b) example materials for nanoscintillators, (c) TEM micrographs of sub ˜7 nm core nanoparticles based on SrLuF host lattice with 25% Ce³⁺ and 25% Pr³⁺ dopants. example SrLuF cores; and (d) a high-resolution (TEM) image of a core-shell nanocube confirming the single crystallinity of the core-shell nanoparticle and a Fast Fourier Transform (FFT) obtained from the particle matching an FCC close-packed structure.

FIG. 4 shows a process for thermal decomposition of rare earth (Ln) and alkaline-earth (M) trifluoroacetate precursors of MLnF to synthesize core-shell nanoparticles. The alkaline-earth rare-earth fluoride M₁₋ₓLnₓF₂₊ₓ (MLnF) core nanoparticles can be synthesized via thermal decomposition of the corresponding TFA salts in the presence of capping ligands in which the Ln³⁺ salts are decomposed at temperatures around 300° C.

FIG. 5 shows TEM micrographs of core-shell scintillator nanoparticles based on SrLuF host lattice with varying dopants type (Ce³⁺ and Pr³⁺) varying concentration (5%-45%) and undoped inert shell of SrLuF

FIG. 6 shows X-ray powder diffraction (XRD) spectra of SrLuF core-shell nanoscintillators with varying dopants concentration (15%-45%) of Ce3+ and Pr3+ match FCC closed packed crystal structure with space group Fm3m.

FIG. 7 shows an example method for time resolved photoluminescence spectroscopy (TRPS) using time-correlated single photon counting (TCSPC).

FIG. 8 shows X-ray excited emission decay dynamics (X-ray induced scintillation) in Ce-doped and Pr-doped SrLuF nanoscintillators.

FIGS. 9A-9B show a schematic of excitation and emission pathways for Ce and Pr dopants.

FIG. 10 shows example results including the lifetime of the excited state and the time needed for 63.2% of excited states to decay.

FIGS. 11A-11B show an example fabrication method for PDMS films with nanoscintillators.

FIG. 12 shows an example Purcell enhanced metamaterial structure, including a schematic of an example Purcell enhanced metamaterial, with unit cell composed of alternating 20 nm Al (gray) and 15 nm BGO scintillator (purple) layers (an example structure), where the unit cell period is 90 nm; equifrequency contours of the metamaterial, indicating both isotropic and hyperbolic dispersion; and Purcell enhancement of a dipole emitting 200 nm light within the metamaterial.

FIG. 13A shows an example self-assembled metamaterial; FIG. 13B is an Electron micrograph of the example self-assembled metamaterial; FIG. 13C shows example optical transmission images for the self-assembled metamaterial tuned for transmitting different wavelengths; 13D shows example RISNR vs. CTR for 20, 30, and 40 diameter cylinders containing positron emitting radionuclides.

FIG. 14 shows another example synthesis of scintillating nanoparticles.

FIG. 15 illustrates an example method for superlattice fabrication through DNA-assisted self-assembly.

FIG. 16 shows an example PET detector ring having a detector, illustrating detector elements.

FIG. 17 shows example annihilation paths for coincidence events.

FIG. 18 shows an example setup to measure energy resolution and CTR of a test crystal.

FIGS. 19A-19E show another example 3D superlattice-based PET system with nanophotonic metamaterials scintillators.

FIG. 20 shows example reconstructed PET image quality for three orders of magnitude using ToF-PET information with 500 ps (top) or 30 ps (bottom), illustrating CTR versus radiation dose or scan time for a cylindrical “phantom” mimicking a radioactive PET tracer concentrating in lesions of various sizes, where for the 100× lower dose or scan time data (box), the ‘lesions’ can only be visualized with the more precise CTR value.

FIG. 21 shows example super scintillators with a gold nanorod (a) and a double silver nanorod (b).

FIG. 22 shows results of a simulation using the example super scintillators of FIG. 21.

FIG. 23 shows an example enhancement factor as a function of a length of a gold nano-rod (a) and of a silver nanorod (b).

FIG. 24A-24C illustrate an example NIR-light-activated photopolymerization mediated by upconversion emission.

FIG. 25 shows an example X-ray imaging using an X-ray CT-scanner as an excitation source to image the scintillation light emitted from drop-casted MLnF nanostructures (65% Ce dopants) on a silicon substrate.

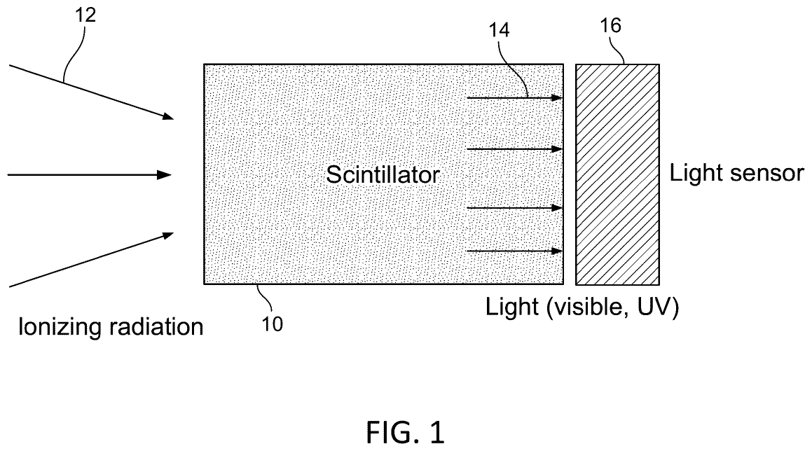

### DESCRIPTION

The interactions between a scintillation crystal and ionizing radiation photons involve the production of primary and secondary charge carriers (on a femtosecond scale), thermalization (sub-picosecond scale) and localization (picosecond scale) of charge carriers, and carrier migration (when charge carriers migrate to luminescent centers) along with radiative recombination (nanosecond scale). The production and emission of scintillation light takes place only at this last stage. The stochastic nature of the processes occurring before scintillation leads to significant statistical fluctuations for the generation of the first scintillation photons.

Increasing PET's reconstructed image signal-to-noise ratio (RISNR) can improve disease visualization, quantification and characterization leading to enhanced lesion detection by human observers. It can also be used to reduce injected radiation dose or study duration. RISNR can be improved by increasing the axial field of view of the system, but at great cost. On the other hand, improving the CTR is a cost-effective way to increase RISNR.

Using conventional scintillation detection, the fundamental limit in PET time resolution is strongly dependent on the inherent temporal variance generated during the scintillation process. Consequently, the CTR achievable by a scintillation-based PET detector using a conventional scintillator material has an intrinsic limit which is estimated to be on the order of 100 picoseconds (ps), and for current commercially available time-of-flight (ToF) PET systems may be in the range of 350 ps.

To overcome such intrinsic limitations for CTR in a scintillation detector, example embodiments provided herein can employ nanophotonic techniques, including plasmonic and metamaterial enhancement, to provide a Purcell enhanced metamaterial or photonic crystal (generally, Purcell enhanced metamaterial) that enhances the light yield and decreases the decay time of scintillation crystals. Example metamaterials may also enhance the prompt component of luminescence, e.g., including the Cherenkov radiation portion of the prompt emissions. A metamaterial is a nanocomposite material (e.g., a nanostructured array) that can manipulate electromagnetic (EM) waves, controlling and enhancing optical properties such as absorption, transmission, and radiative emission.

Example scintillation detectors for photons can include a Purcell enhanced metamaterial or photonic crystal that converts 511 keV photons into visible light photons. Some example embodiments herein provide a Purcell enhanced scintillator, referred to herein as a “super scintillator,” based on nanophotonic, Purcell enhanced metamaterials to substantially boost temporal resolution for radiation imaging applications, with example applications including advancement of medical imaging, e.g., for biomedical research and for clinical applications. This is believed to be the first application of nanophotonic materials and metamaterials to radiation detectors and medical imaging.

Example methods herein can combine Purcell enhanced metamaterial fabrication with scintillator materials synthesis for a PET detector design. Example detectors can substantially improve ToF PET performance and facilitate progress in the study and clinical management of cancer, cardiovascular disease and neurological disorders, as nonlimiting examples.

Example Purcell-enhanced metamaterials can generate significantly improved light yield (e.g., >10× more scintillation light) and significantly improved decay time (e.g., >100× shorter decay time) compared to standard scintillation crystals. Purcell enhanced scintillation can be used to achieve significantly improved coincidence time resolution (CTR), as a nonlimiting example, as low as less than 50 picoseconds (ps), less than 40 picoseconds, less than 30 picoseconds, less than 20 ps, or even less than 10 ps annihilation photon pair coincidence time resolution. Such advances can greatly increase (e.g., 6× or greater) PET's RISNR, enhancing lesion visualization and quantification of disease using PET, and enabling reduction of radioactive dose, and/or scan time. Less than 10 ps CTR, for example, is an order of magnitude better than possible with the most precise scintillation-based PET detectors studied in research and 20-fold better than the state-of-the-art TOF-PET scanners available in industry.

However, Purcell enhanced scintillation as provided herein is not limited to PET applications, but can generally be provided in applications including but not limited to diagnostic imaging (including computed tomography, single photon emission computed tomography, and PET), security radiation monitoring, gamma-ray energy harvesting, X-ray security monitoring, gas exploration, and monitoring radioactive contamination.

Preferred embodiments will now be discussed with respect to the drawings. The drawings include schematic figures that are not to scale, which will be fully understood by skilled artisans with reference to the accompanying description. Features may be exaggerated for purposes of illustration. From the preferred embodiments, artisans will recognize additional features and broader aspects of the invention.

For a scintillator based detector, coincidence time resolution (CTR) can be determined using CTR=A\sqrt{τᵣτ_{d}/Nₚₑ}, where A depends on non-scintillator factors such as the crystal surface treatment, crystal transit time variance, photodetector time jitter, and the properties (bandwidth, time jitter, etc.) of readout electronics, and where τᵣ is the scintillator rise time, τ_{d} is the scintillator decay time, and Nₚₑ is the number of photoelectrons produced in the photodetector (dependent on scintillator light yield and photodetector efficiency). Thus, increasing the light yield and/or decreasing the rise and decay time will improve the CTR.

Luminescence decay includes radiative decay and non-radiative decay. The excited electrons have the tendency to relax back to a lower level after a time interval that is referred to as lifetime. During relaxation electrons release energy both in the form of radiative and non-radiative transitions. Radiative transitions involve absorption or emission of a photon (allowed in direct-band gap materials). The energy difference is emitted or absorbed in form of photons. For non-radiative transitions, transition energy is transformed into forms other than light, e.g., the energy difference can result in lattice vibrations such as heat. Phonons are emitted to crystal lattices or electrons are trapped in defects.

The stochastic nature of scintillation leads to significant temporal fluctuations, limiting the CTR achievable by standard PET scintillation detectors to about 100 ps. For example, one of the fastest scintillators for PET, calcium co-doped LSO has a rise time of 21 ps vs. 70 ps for LSO: Ce, but still achieves >100 ps CTR.

An improved scintillation crystal for PET, for instance, will include high Z, providing high stopping power, short decay time, providing good coincidence timing, an emission wavelength near 350 nm, which is a good match for a photomultiplier tube (PMT) response, and transparency at emission wavelength, to minimize reabsorption.

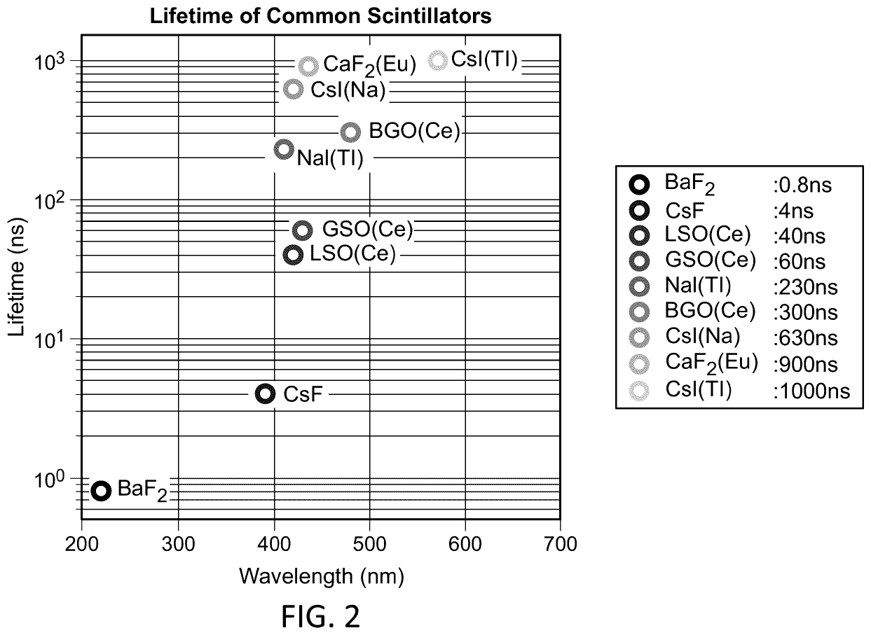

Common bulk scintillators are plotted in FIG. 2 based on their decay constant and scintillation wavelength, ranging from BaF₂ with sub-nanosecond decay constant with extreme UV emission wavelength, to thallium activated NaI and CsI (thallium-doped sodium iodide and cesium iodide) as two of the most popular scintillators with decay constants about ˜200 ns and ˜1000 ns respectively.

BaF₂, for example, as an ultrafast scintillator has extremely low radiative efficiency, as crossluminescence is the major emission mechanism in BaF₂ and is highly dependent on the low probability of forming holes in the upper core band. Its peak emission is also in the far UV at 220 nm, which may require the use of suitable photodetectors, such as photodetectors with quartz windows.

The spontaneous photoemission rate from free charge carriers can be enhanced by a local environment, an effect referred to as the Purcell effect. A form of spontaneous emission, the scintillation photon emission can be enhanced by engineering the surroundings of the scintillation source. Generally, a dielectric cavity resonator can resonate with the photon-emitting atoms to generate more emissions. The dielectric cavity provides a higher density of final states (e.g., electromagnetic local density of states (LDOS)), which leads to a higher transition rate of the atom-free space system according to Fermi's golden rule. The magnitude of the Purcell effect can be described as the Purcell factor, which is given as:

$${F}_{p} = \frac{3}{4 {π}^{2}} {( \frac{{λ}_{free}}{n} )}^{3} ( \frac{Q}{V} )$$

where λ_{free}/n is the wavelength within the cavity resonator of refractive index n, Q and V are the quality factor and the mode volume of the resonator, respectively. To maximize the Purcell effect, high-Q resonance modes with small mode volume are crucial.

The surface plasmon resonance, the collective oscillation of the polaritons on the conductive surface, exhibits an extremely short wavelength compared to the free space wavelength owing to the extremely high negative permittivity of conductive material. These confined optical modes have extremely small mode volume, which leads to higher Purcell factor.

Providing Purcell enhancement improves the performance of scintillators in various ways. For example, the fast component of scintillation light is produced by fluorescence. Consequently, the fluorescence light yield and decay time are the major contributors to scintillator CTR. Because of the enhanced spontaneous emission rate of an emitter via the Purcell effect, an excited state emits photons more rapidly, which corresponds to a shortened lifetime of the emitter and hence a faster emission decay. This gives a faster response and more photons in a shorter time, therefore increasing the scintillator SNR.

In addition, the higher spontaneous emission rate typically enhances the emitter's efficiency because it outperforms other competing slower processes, such as non-radiative phonon relaxation, that reduce the light yield. For example, the fluorescence quantum yield may be given by:

$${Q}_{f} = \frac{{\dot{F}}_{P} {k}_{f}}{{F}_{P} {k}_{f} + {k}_{nf}}$$

where F_{P} is the Purcell factor, k_{f} is the fluorescence radiative rate, and k_{nf} is the non-fluorescence deactivation rate. Purcell enhancement of the fluorescence radiative rate can also increase the light yield of the scintillator.

Metamaterials are three-dimensional electromagnetic materials including or consisting of subwavelength interacting unit cells serving as “artificial atoms.” Due to the subwavelength nature of example metamaterials, the metamaterials offer a range of tunable and enhanced properties and functionalities, unattainable in natural materials, by engineering the arrangement and geometry of the internal physical structure of their constituents. However, it is not required for all embodiments herein that all metamaterials be subwavelength in size.

An example metamaterial can be configured to improve or maximize Purcell enhancement by increasing the number of radiative states available to a scintillator, leading to a faster response and more photons in a shorter time, and decreasing the decay time. In addition, the higher spontaneous emission rate typically enhances the emitters' efficiency because it outperforms other competing slower processes, such as non-radiative phonon relaxation, which reduce the light yield. Example metamaterials providing Purcell enhancement are thus referred to herein as Purcell enhanced metamaterials or photonic crystals (and more generally, Purcell enhanced metamaterials). Example metamaterials or photonic crystals can be provided for Purcell enhancement for scintillation applications.

Example approaches can use nanophotonic structures to enhance the scintillation process. Nanophotonic structures can be applied to any scintillating material, such as but not limited to alkaline-earth rare-earth fluoride (MLnF), lutetium oxyorthosilicate (Lu₂₍₁₋ₓ₎ Ce₂ₓSiO₄ (LSO)), Bismuth Germanate (Bi₄Ge₃O₁₂, or BGO), LuₓY₂₋ₓSiO₅:Ce (LYSO), or ceramic scintillators.

Various nanophotonic techniques may be employed to increase the Purcell effect. Nonlimiting examples include plasmon resonances in metallic NPs or shells, and Mie modes in high-refractive dielectric nanoparticles, as well as other examples provided herein. Different conducting structure-scintillator combinations, e.g., conducting or plasmonic material (for example, metal) thicknesses and dielectric thicknesses and/or unit-cell dimensions, may be incorporated to optimize efficiency of an example PET detector, and such variations are to be considered part of the present disclosure.

Rare earth (RE) doped scintillators use dipole allowed f-d transition states for fast scintillation with short decay time. In some example embodiments, alkaline-earth rare-earth fluoride (MLnF, where M is alkaline earths, Ln is rare-earths, and F is fluoride) core-shell nanoscintillators are provided that include a host material and luminescence centers (dopants) as the core and an undoped host material as a shell. The core nanoparticles may be doped with lanthanide ions with a fast spontaneous emission rate, and may be provided as useful building blocks for scintillators. However, the invention is not intended to be limited to MLnF materials, as other materials my be used.

To fulfill criteria for an ideal scintillator (high Z, short decay time), example solution processable (wet-chemical method) nanoscintillators can be based on a SrLuF (or MLnF) host lattice, as a nonlimiting example, with an FCC close packed structure in which some of the Lu sites depending on the dopant concentrations are exchanged with either cerium (Ce) or praseodymium (Pr) trivalent. Ce³⁺ and Pr³⁺ dopants offer fast spontaneous emission with a short radiative lifetime in the nanosecond (ns) regime, which is desirable for designing ultrafast scintillators. Most Lanthanides exhibit intra 4f transitions (parity forbidden transition) and long decay constant (ms). Excluding those lanthanides where non-radiative relaxation to high-lying 4f-levels takes place suggests Ce³⁺, Pr³⁺, and Nd³⁺ as good options for designing fast decay scintillators.

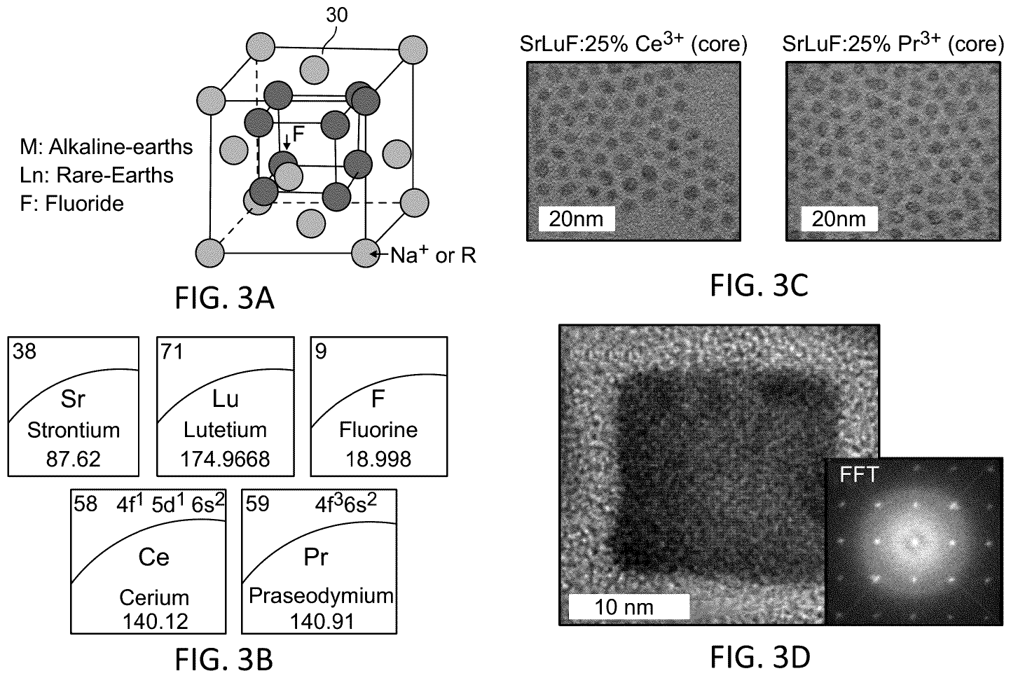

Example Ce³⁺ and Pr³⁺ doped nanoscintillators use dipole allowed transitions (interconfigurational transitions) between 4f and 5d states for fast scintillation with short radiative decay lifetime. 5d→4f transitions give rise to a change in dipole moment and therefore are allowed transitions both by spin and parity selection. The parity-allowed 4f→5d transition further results in large absorption cross section in UV region. In addition to good photo-stability of the host material (SrLuF), the high effective Z of the host materials (SrLuF: 54.5) offers a high performance in absorbing the incident high energy ionizing radiation and therefore short attenuation length, as illustrated in FIG. 3, which shows an FCC structure 30 of MLnF core-shell nanoscintillators (FIG. 3, (a)) and shows example materials for nanoscintillators, based on Sr, Lu, F (SrLuF) as a host lattice and Ce³⁺ and Pr³⁺ with allowed f-d interconfigurational transition as luminescence centers (FIG. 3, (b)).

A range of structural, optical and X-ray characterization techniques for colloidally synthesized nanoscintillators can be employed to identify the compositional dependence of emission wavelength and emission decay dynamics. Colloidal synthesis, for example, can be a cost-efficient and scalable (multigram) approach.

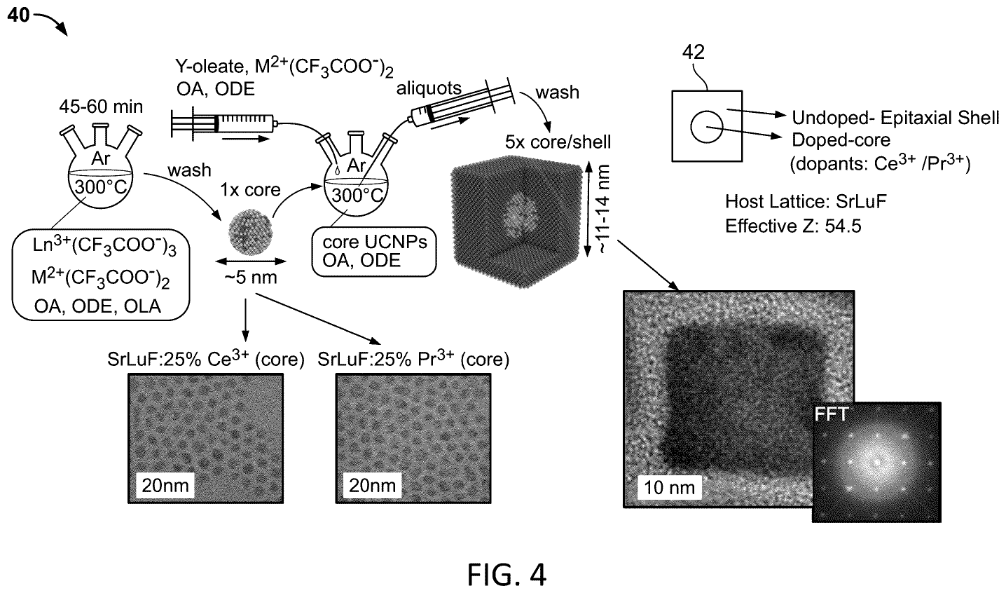

An experiment synthesized monodisperse, sub 20 nm diameter MLnF nanoparticles doped with high Z trivalent lanthanides with concentrations systematically varying from 5%-45% via colloidal synthesis as a scalable (multigram) approach. FIG. 4 illustrates an example thermal decomposition process 40 during which core-shell nanoparticles may be synthesized. An example two-step synthesis procedure is based on the thermal decomposition of alkaline-earth (M) and rare-earth (Ln) trifluoroacetate salts, e.g., in a 1:1 molar ratio in oleic acid (OA), 1-octadecene (ODE), and oleylamin (OLA) at 300° C. under inert atmosphere (Ar).

To increase the luminescence efficiency the core nanoparticles may be shelled, e.g., in a separate step. The shell layer suppresses the potential detrimental impact of surface defects on active core particles as major energy loss contributors and other potential factor that may result on quenching the luminescence emissions.

The core nanoparticles with dopants can be synthesized and serve as seed crystals with surface nucleation sites for epitaxial growth of shell layers. During a post processing procedure, the preprepared trifluoroacetates shell precursor can be hot injected (˜270° C.) into the core nanoparticle solution via a syringe pump with slow injection rate (2 mg/hr) (dropwise hot injection) and can be incubated to provide or ensure efficient nucleation and growth of the shell. The final core-shell products are capped with oleate ligands. FIG. 4 also shows an example SrLuF host lattice 42.

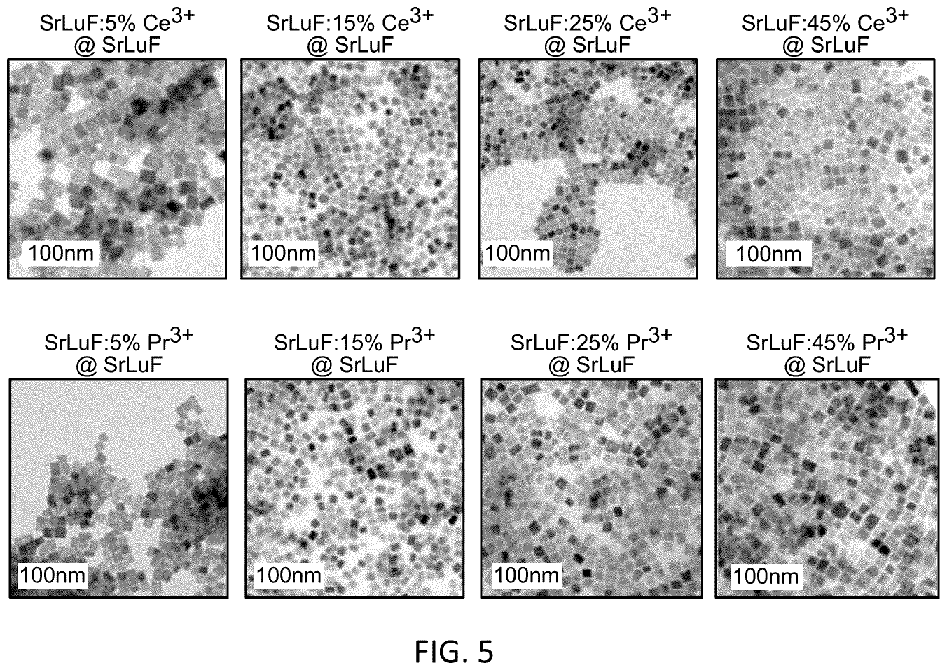

FIG. 5 shows TEM micrographs of example core-shell scintillator nanoparticles based on an SrLuF host lattice with varying dopants type (Ce³⁺ and Pr³⁺) varying concentration (5%-45%) and undoped inert shell of SrLuF. The TEM images reveal a relatively narrow size distribution with a consistent nanocube morphology.

The synthesized nanoparticles may represent, for example, a library of colloidal nanocrystal scintillators synthesized with the choice of Ce³⁺ or Pr³⁺ and nominal dopant concentration of (5%-45%). An extended database can be provided of synthesized scintillating nanomaterials as basic building blocks. This can provide near atomic modification of nanoscale luminescence properties and a wide range of tunability, and allow design flexibility to optimize scintillation properties over a broad spectral range for various applications. Example nanoparticles for a database or library may include, as nonlimiting examples, bismuth germanate (Bi₄Ge₃O₁₂, BGO) alkaline-earth rare-earth fluoride nanoparticles (MLnF), or any other suitable material, e.g., with controlled shape, size, and/or crystallinity and precise chemical dopants that may be provided to tune emission properties.

Example methods can employ a range of optical and structural characterization techniques to identify, for instance, the compositional dependence of decay lifetime and scintillation response. Tools such as transmission electron microscopy (TEM), X-ray diffraction (XRD), and chemical analysis tools can be used to characterize properties of the ScNPs. TEM, for instance, can be used to measure the size and morphology of the NPs. XRD and chemical analysis tools can be used to verify the chemical and structural composition of the NPs.

As a nonlimiting example, to understand scintillation properties, one can consider both steady state and time resolved X-ray luminescence response from the nanoparticles. In an example method, powder X-ray diffraction (XRD) patterns are measured using a diffractometer to identify the crystalline phase of the MLnF nanoscintilators, and the measurement range was 2θ=10-90°. The X-ray source was Cu Kα1 radiation (λ=0.15406 nm) with a bias voltage of 40 KV and a tube current of 45 mA. A 0.05 o with a scanning rate of 40/min. The reference pattern of SrLuF was obtained from International Center for Diffraction Data (ICDD).

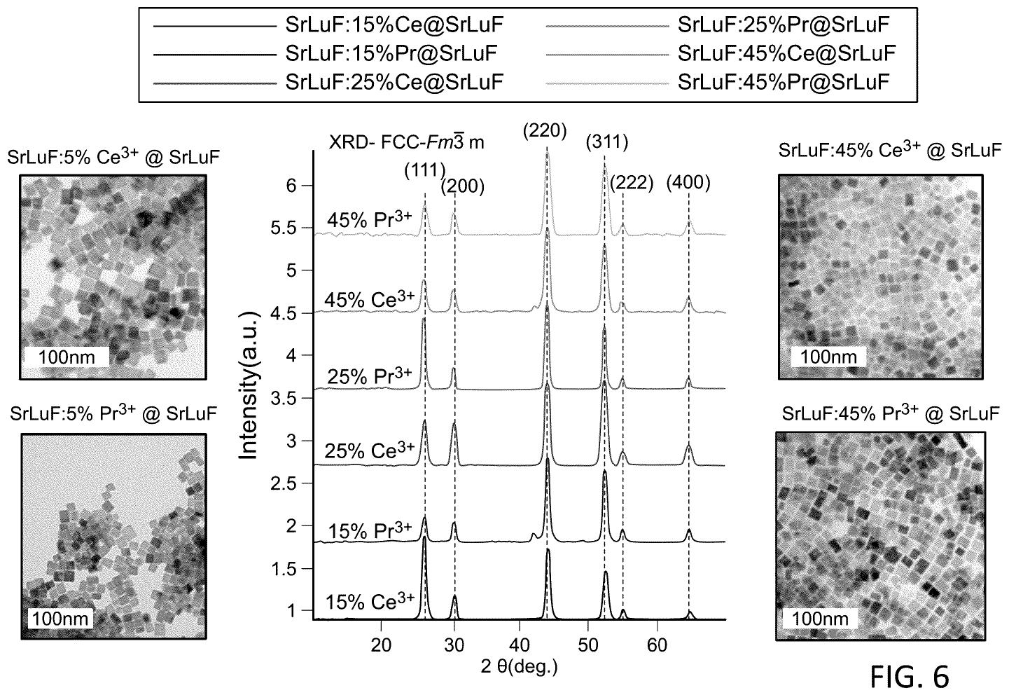

FIG. 6 shows X-ray powder diffraction (XRD) spectra of SrLuF core-shell nanoscintillators with varying dopants concentration (15%-45%) of Ce³⁺ and Pr³⁺ match FCC closed packed crystal structure with space group Fm3̅m. The samples further confirmed the face-centered cubic (FCC) close packed structure of all MLnF samples with space group Fm3̅m. The results indicate that the crystal structure did not experience any significant crystallography changes as a result of doping with Ce and Pr.

Optical properties of the lanthanide doped core-shell nanoparticles can be further evaluated using time resolved photoluminescence spectroscopy (TRPS) and steady state X-ray excited optical luminescence (XEOL) as well as time-resolved XEOL. Using these optical characterization techniques, the X-ray excited luminescence emission can be measured, as well as UV and X-ray excited decay dynamic spectra to identify the compositional dependence of Ce³⁺ 4f→5d (²F_{7/2}+²F_{5/2}) decay lifetime.

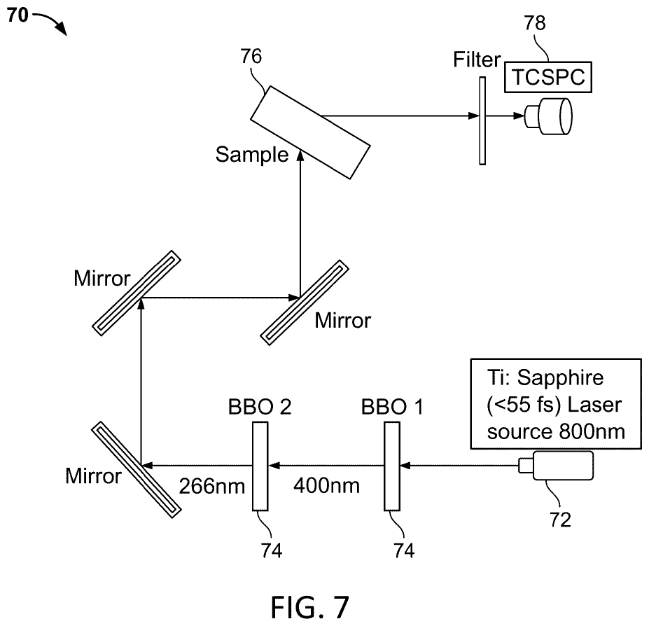

FIG. 7 shows an example time resolved photoluminescence spectroscopy (TRPS) method 70. Using a time-correlated single photon counting (TCSPC) technique, the UV excited decay dynamics (time-dependent luminescence lifetime) of Ce³⁺ 4f→5d (²F_{7/2}+²F_{5/2}) transition is recorded using 266 nm excitation wavelength, which is a third harmonic generation of 800 nm Ti/sapphire laser source 72 with 55 fts pulses. BBO (Barium Borate) crystals 74 are used to generate the second and third harmonics of the Ti: Sapphire laser 72. The laser passes through a sample 76, and is filtered and counted using a single photon counter 78 having a fast hybrid PMT (PMA Hybrid; PicoQuant).

TCSPC measures the time between one START event and one STOP event. The difference between START and STOP is sorted into bins. The time differences can be shown in a histogram representing fluorescence intensity versus time. Additional photons are counted and data is collected until, for instance, the highest histogram point reaches approximately 10000 counts.

An inner system crossing and triplet excited states (Phosphorescence) can provide a longer lifetime and redshift. It can be useful to determine how long it takes for this electron to get back to ground states, e.g., as affected by surface traps due to unsaturated bonds on the surface of the nanomaterial. A PL decay provides t, or the lifetime of the excited state. To determine an average amount of time that takes for the sample to emit light, a kᵣ radiative decay constant and kₙᵣ non-radiative decay constant may be used, with

$$τ = \frac{1}{{k}_{r} + {k}_{n r}} .$$

A free Ce³⁺ ion with 4fl electronic configuration has two ground states, namely ²F_{5/2} and ²F_{7/2}. Once with one electron excited from 4f to 5d, the 5d electron of the exited 4f05d1 configuration forms a 2D term, which is split by spin-orbit coupling, and two lower energy levels of ²D_{3/2} and ²D_{5/2} states are formed. Therefore, the excitation bands peaked at 338 and 460 nm are attributed to ²F_{5/2} (or ²F_{7/2})→²D_{3/2} and ²F_{5/2} (or ²F_{7/2})→²D_{5/2} transition, respectively. Electrons on the higher energy level of ²D_{5/2} state are unstable, which would relax to ²D_{3/2} state with electron-phonon interaction. Therefore, an emission band may be attributed to ²D_{3/2}→²F_{7/2} or ²F_{5/2} transition. Because the radial wave function of the excited 5d electron extends spatially well beyond the closed 5s25p6, its states are strongly perturbed by the crystal field.

Thus, both the strongest excitation band and the strongest emission band are associated with the lowest-lying 5d state, which is affected by crystal field. According to the configuration-coordinate model, the nonradioactive transition from excited states to ground state increases with an increase of temperature.

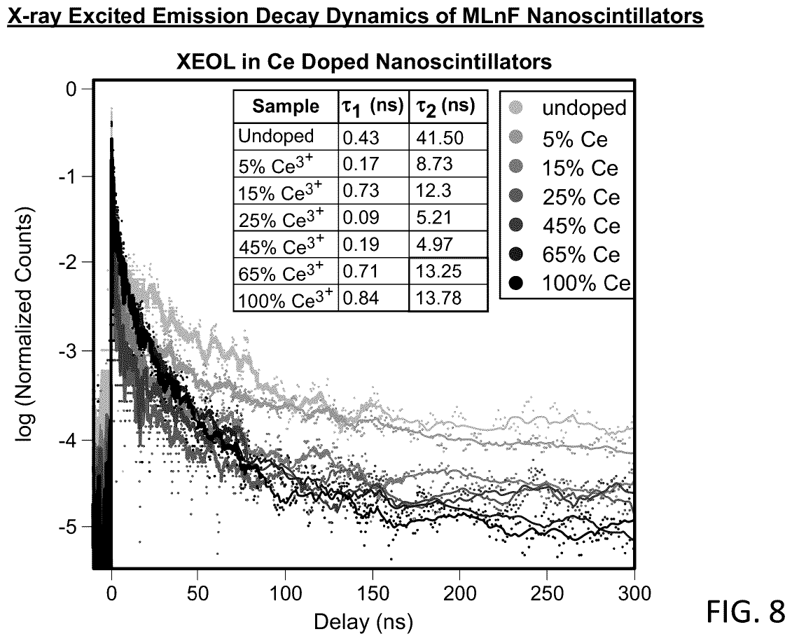

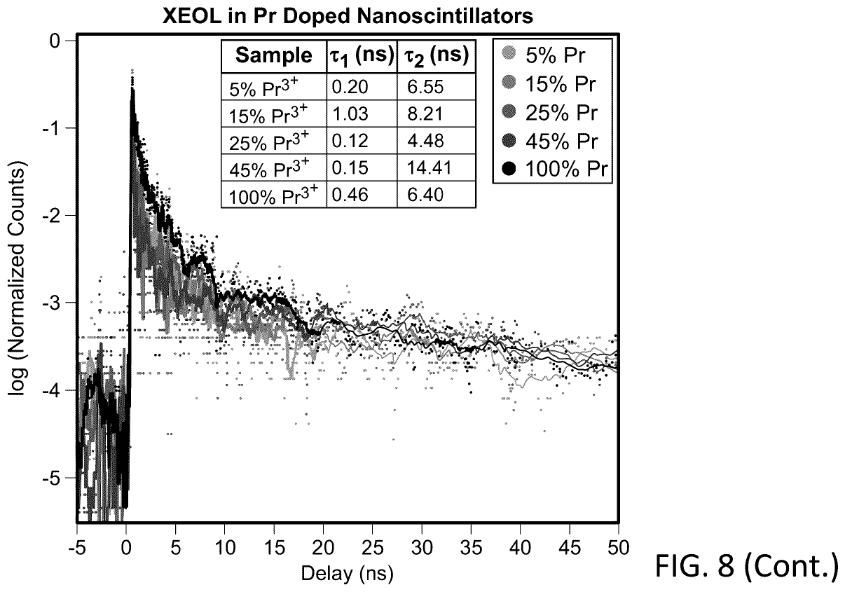

FIG. 8 shows X-ray excited emission decay dynamics (X-ray induced scintillation) in Ce-doped and Pr-doped SrLuF nanoscintillators. FIG. 8 (a and b) show the time-dependent luminescence decay curves, and the decay constants are listed in the onset tables. The measured time constant is ˜5-13 ns for the Ce-doped samples and ˜41 ns for an undoped sample (host lattice) and varies between ˜4-14 ns for Pr-doped samples. 45% doped Ce and 25% Pr doped samples exhibit the fastest decay response of ˜4-5 ns.

Steady state and time resolved X-ray excited optical luminescence (XEOL) of MLnF nanoscintillators was studied using 50 kV X-rays to excite the samples and probed the subsequent luminescence response. The samples were prepared by drop-casting 10 mg of nanoparticles on a silicon substrate. The tests were conducted using steady state X-ray Luminescence, with an X-ray tube: 50 KV, 50 mA, a Cu anode. Emission was detected by a CCD integration t=60 s, mono slit 500 um; time resolved X-ray Luminescence; X-ray set at 40 kV. The emitted photons were detected by a MCP-Photo multiplier tube (PMT) biased at 3000 V with high sensitivity in blue and near-UV region.

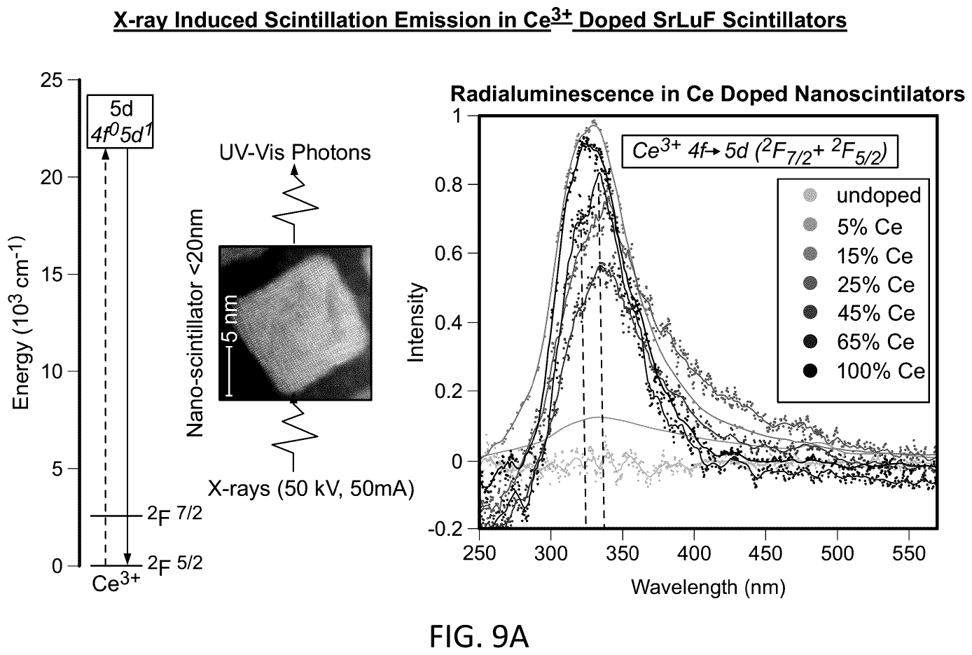

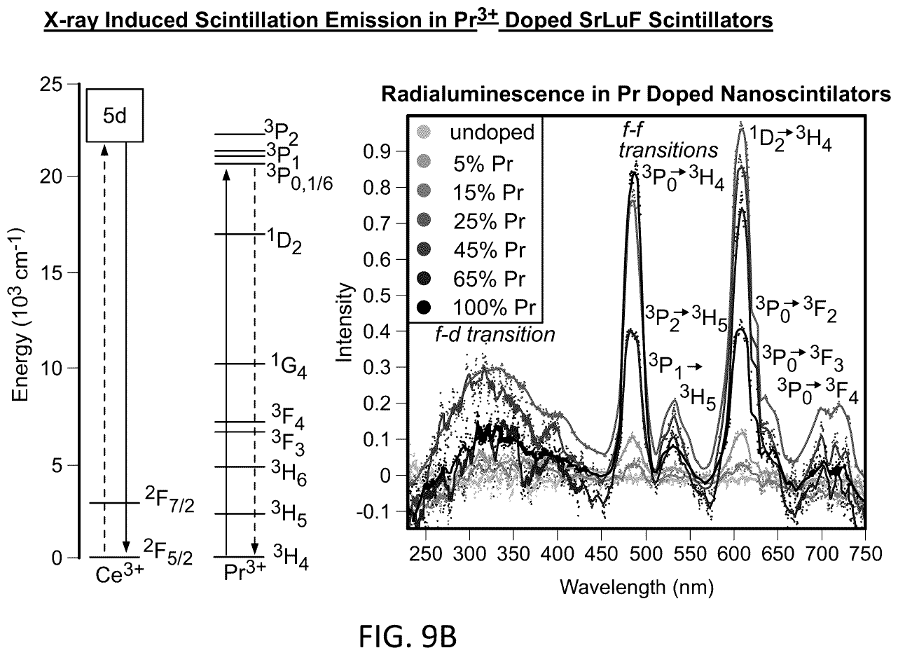

FIGS. 9A-9B show a schematic of excitation and emission pathways for Ce and Pr dopants. Steady state X-ray scintillation response of MLnF nanostructures was recorded at room temperature for both Ce and Pr doped MLnF nanostructures are shown in FIGS. 9A-9B.

Broad band emissions in near visible regime with a peak ˜335 nm in Ce-doped samples and ˜325 nm in Pr-doped samples are ascribed to 4f-5d transitions and are consistently observed for both Ce and Pr doped MLnF nanoscintillators. The broadening in the 4f to 5d emission bands is due to the strong coupling of the 5d-electrons with the lattice phonons. In addition to the 4f-5d transitions, a series of parity forbidden intra 4f transitions with longer decay lifetime (in millisecond regime), small line width and longer emission wavelengths are identified in Pr doped samples in visible region (400-700 nm). For Ce doped samples only the 4f-5d emissions were observed.

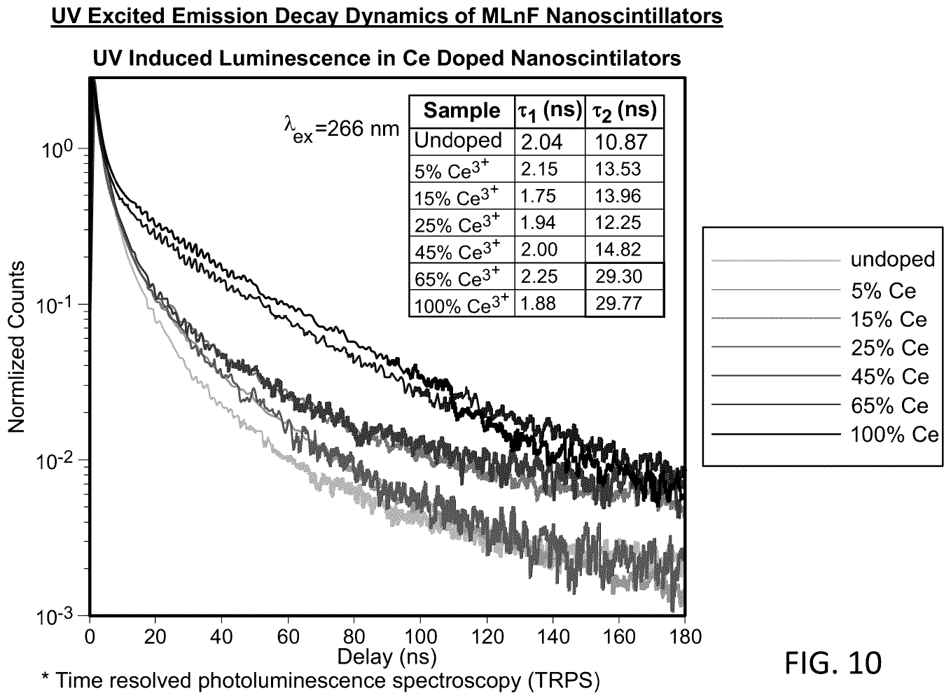

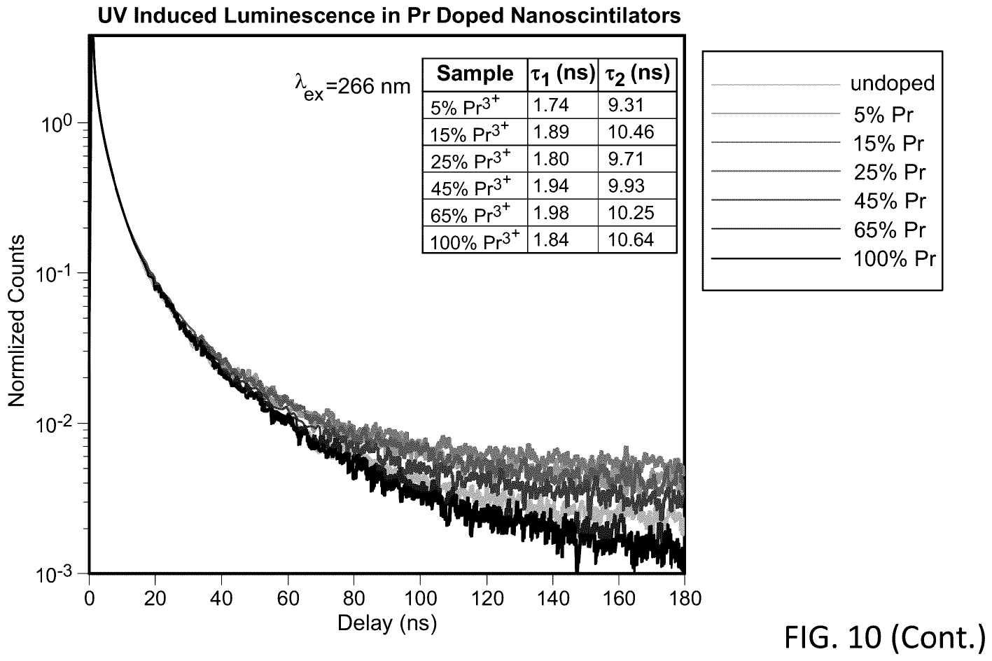

FIG. 10 shows example results including the lifetime of the excited state and the time needed for 63.2% of excited states to decay. Using the example time-correlated single photon counting (TCSPC) technique, the UV excited decay dynamics (time-dependent luminescence lifetime) of Ce³⁺ 4f→5d (²F_{7/2}+²F_{5/2}) transition were recorded using 266 nm excitation wavelength (third hormonic generation of 800 nm Ti/sapphire laser with 55 fts pulses). The decay lifetime is calculated from exponential fits to the temporal profiles.

The onset tables in FIG. 10 illustrate the obtained PL decay time constants for Ce-doped and Pr-doped samples. The measured decay lifetime (t) for Ce-doped samples varied between ˜13 ns to ˜30 ns. There is an upward trend in decay lifetime observed for Ce-doped samples, with 25% Ce having the fastest lifetime and 100% Ce (nominal concentration) having the slowest decay lifetime. The increased decay constant in higher concentration of Ce-doped samples may be due to the cross-relaxation process as the neighboring emission centers (Ce dopants) are getting closer to each other. In addition to the possibility of luminescence quenching, higher number of lattice defects are also attributed to longer decay lifetime. For Pr doped samples only the short-lived decay component corresponding to the f-d transition is provided, and a significant change in lifetime increasing the dopant concentration was not observed. The calculated decay lifetime is around ˜10 ns with a ˜1 ns modulation as the dopant concentration was changed.

To illustrate the scalability and flexibility of example methods, a highly transparent bulk-size nanoscintillating structure was constructed in which the MLnF core-shell nanostructures are the basic building blocks. Nanoscintillators were incorporated into a flexible elastomer of PDMS to form an optically clear scintillator film that is a PDMS and MLnF nanocomposite, and the scintillation response of the PDMS and nanoparticles composite film was investigated. PDMS is a two-part polymer, including a pre-polymer or base elastomer and cross-linker or curing agent. Example scintillator films and methods can ultrafast, low-cost and flexible scintillator materials.

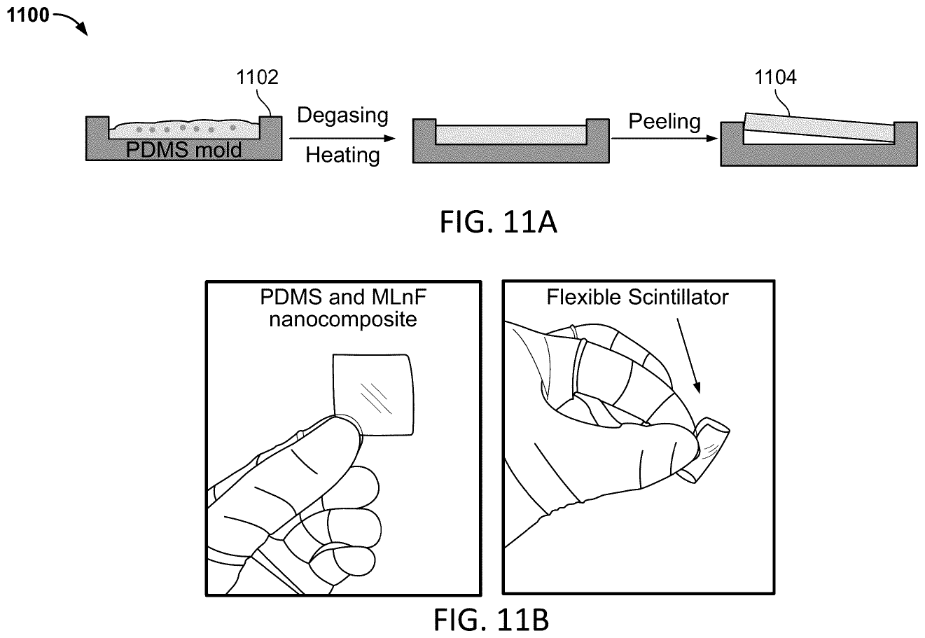

FIG. 11A shows an example method 1100 for making MLnF and PDMS nanocomposite film. The method 1100 includes: i) vapor silanization of a PDMS mold 1102, ii) combining (e.g., mixing) the PDMS with the nanoscintillators (e.g., MLnF), as a non-limiting example, with a 4:1 volume ratio, iii) degassing the mixture in a vacuum chamber for 1 hr, and iv) annealing the mixture in PDMS, e.g., for 1 hr at 800 C. The resulting film 1104 is then peeled from the PDMS mold. FIG. 9B shows a 4 mm thick optically clear PDMS and nanoscintillator composite film, which can provide a flexible scintillator.

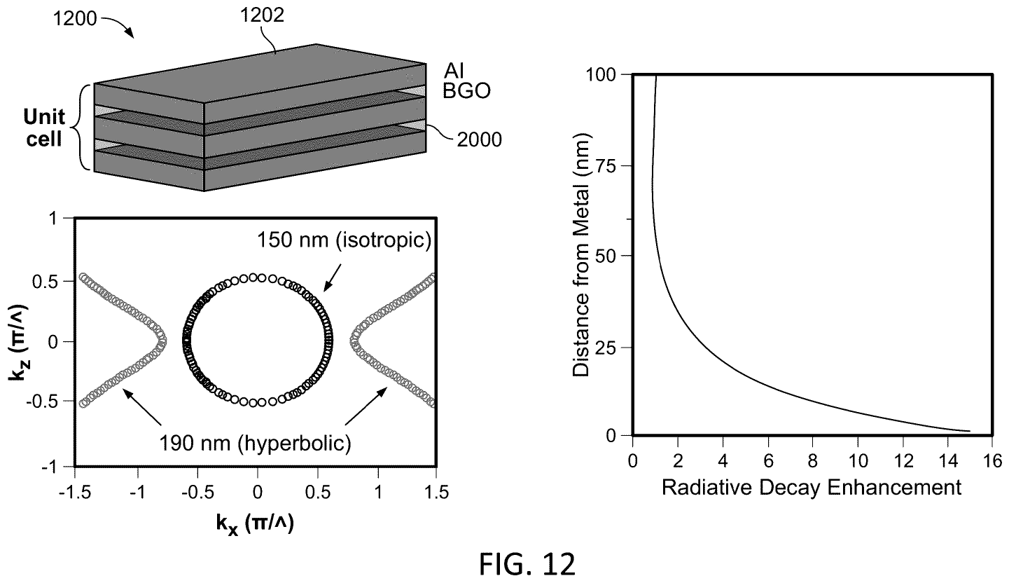

Example metamaterials may be designed across a range of emission frequencies and configurations, including structures and NP arrangements. FIG. 12 shows an example Purcell enhanced metamaterial structure 1200 according to an embodiment with a unit cell having alternating conductive structures 1202 of conducting or plasmonic material, e.g., metal (e.g., aluminum, silver, gold, etc.) and dielectric (scintillator) layers 1204. An example unit cell period is 90 nm. Each conducting and scintillator structure 1202, 1204 in the example metamaterial 1200 can be deeply subwavelength in thickness (e.g., 20 nm and 15 nm, respectively), ensuring the metamaterial acts like a homogeneous material transparent to UV and visible light. However, it is also possible that one or more of the structures (e.g., up to all of the structures) can have a thickness greater than subwavelength.

By tailoring the thickness of each structure (e.g., layer or other structure), the unit cell dimensions, and/or the emission polarization, one can tune the optical bandstructure from an isotropic medium to a hyperbolic medium. The bandstructure at a particular frequency forms an isofrequency contour (EM wave vector k for a constant frequency), where the slope indicates the effective n. An example binary superlattice in which NPs are arranged in layers can be constructed similarly to that disclosed in H. Alaeian and J. A. Dionne, “OSA|Plasmon nanoparticle superlattices as optical-frequency magnetic metamaterials.” https://www.osapublishing.org/oe/abstract.cfm?uri=oe-20-14-15781, 2019. Another example metamaterial configuration may be embodied in a metal/insulator/metal metamaterial with alternating layers of ScNPs and continuous metallic films, and may be constructed similar to that disclosed in J. A. Dionne, L. A. Sweatlock, M. T. Sheldon, A. P. Alivisatos, and H. A. Atwater, “Silicon-Based Plasmonics for On-Chip Photonics,” IEEE J. Sel. Top. Quantum Electron., vol. 16, no. 1, pp. 295-306, January 2010.

The Purcell enhanced metamaterial can also modify an emitter's radiative decay rate, and further can increase the efficiency of visible emission by increasing the probability of radiative decay within the scintillator. FIG. 12, left, shows equifrequency contours from full-field EM simulations of a Purcell enhanced metamaterial including alternating structures of Al and BGO. As seen, the equifrequency contours can be isotropic (circle) or hyperbolic (hyperbola) depending on the polarization or wavelength. FIG. 12, right, shows an example decay rate for a dipole within a multilayer metal/dielectric metamaterial calculated from the power radiated by a dipole normalized to its radiated power in a homogeneous material. The dipole emits 200 nm light near the example metamaterial. The decay rate increases by a factor greater than 10 when the dipole is near the conductive structure (e.g., metal layer).

Example Purcell enhanced scintillators can be fabricated from scintillating nanocrystals and plasmonic or dielectric nanoparticles. In some example embodiments, example Purcell enhanced scintillators are provided using one or more methods exploiting alkaline-earth rare-earth fluoride (MLnF) and plasmonic nanoparticles (NPs) synthesis. However, the invention is not limited to MLnF materials, and other materials may be used.

Some example super scintillator fabrication methods can use 3D printing and/or self-assembly. For example, a 3D superlattice and macroscale 3D printing or self-assembly of building blocks can be configured or optimized using methods provided herein. 3D printing can be used, for instance, to fabricate large-area 3D superlattice metamaterials. Example 3D printing methods can use MLnF (or other material) NPs and conductive NPs as building blocks to print a 3D macroscale superlattice structure as a scintillator detector. Scintillation properties can be characterized using novel characterization methods using x-ray and gamma-ray excitations.

Novel nanophotonic approaches are provided for fast and low-cost metamaterial scintillators based on self-assembly of NPs. Example approaches to increase the LDOS include, but are not limited to, plasmon resonances in metallic NPs or shells, and Mie modes in high-refractive dielectric nanoparticles. Example scintillating nanoparticles can be 3D printed to create metamaterial scintillating detectors.

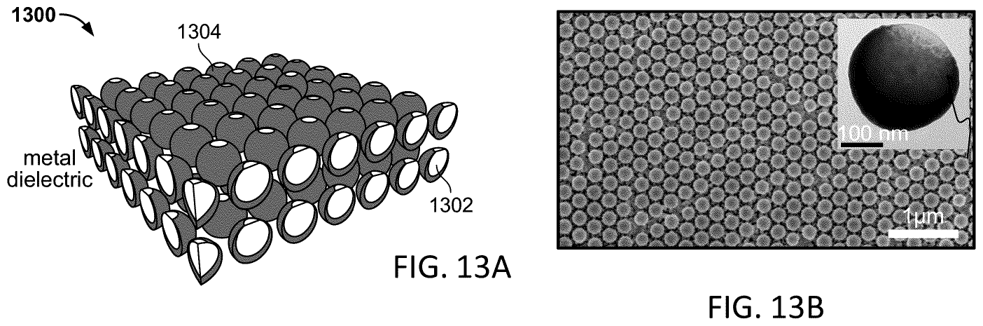

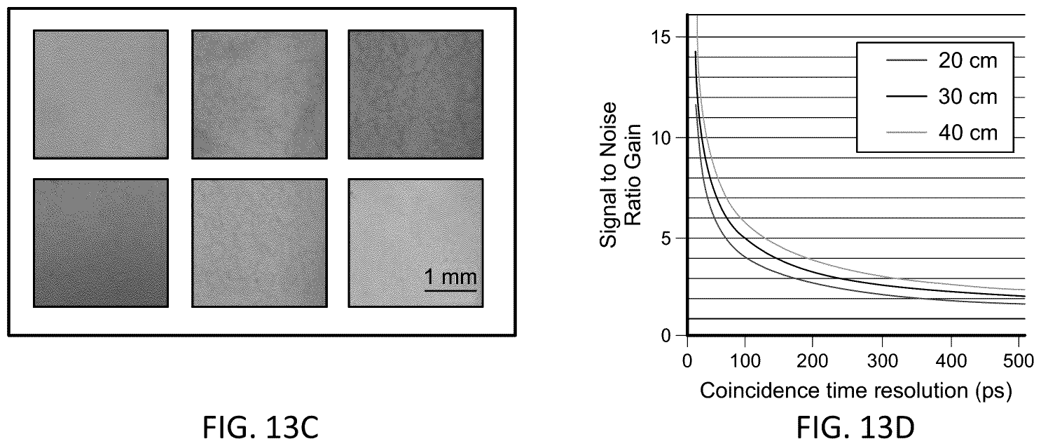

FIG. 13A shows an example self-assembled metamaterial 1300 embodied in a superlattice of scintillating nanoparticles 1302 with a plasmonic metal crescent-layer 1304, which provides advanced scintillation properties, such as additional luminescence and/or shorter decay time. FIG. 13B is an electron micrograph of the example self-assembled metamaterial 1300. The metamaterial 1300 includes an assembly of scintillating nanoparticles (ScNPs) 1302, which may be referred to as nanocrescents, with a plasmonic metal crescent layer embodied in a metallic nanoparticle layer or shell 1304 generally surrounding a dielectric structure. The metal coating 1304 may be replaced with other metallic NPs near the scintillating NPs 1302, or even with a continuous metallic film.

Due to their subwavelength nature, some example Purcell enhanced metamaterials can offer a range of tunable and enhanced properties and functionalities, unattainable in natural materials, by engineering the arrangement and geometry of internal physical structure of their constituents. Example super scintillators can provide an enhanced light yield and ultra-short decay lifetime via, for instance, a periodic superlattice giving rise to an anisotropic and directional emission of photons from luminescence centers.

Example metamaterials can precisely tailor light-matter interactions at the nanoscale, enabling controlled and enhanced absorption and emission. A configuration of ScNPs near metals can be designed to produce a metamaterial scintillator with improved luminescent properties over known scintillators. FIG. 13C shows example optical transmission images for the self-assembled metamaterial tuned for transmitting different wavelengths.

Example embodiments provide 3D printing methods for nanophotonic materials, such as example metamaterials. Offering extensive design flexibility, 3D printing is a cost-effective approach for fabricating complex 3D structures through stacking sequential layers, e.g., see M. Barnes, S. M. Sajadi, S. Parekh, M. M. Rahman, P. M. Ajayan, and R. Verduzco, “Reactive 3D Printing of Shape-Programmable Liquid Crystal Elastomer Actuators,” ACS Appl. Mater. Interfaces, vol. 12, no. 25, pp. 28692-28699, June 2020; and H. Guo, R. Lv, and S. Bai, “Recent advances on 3D printing graphene-based composites,” Nano Mater. Sci., vol. 1, no. 2, pp. 101-115, June 2019.

For example, it is useful to produce large area and thick metamaterials for applications including, but not limited to, PET detector elements. A typical BGO PET scintillator crystal size is 3×3×20 mm³, requiring large-volume metamaterials to improve 511 keV photon detection efficiency. An example nanophotonic approach and large-scale assembly can be combined to make a mm-size scintillator based on nanoparticle building blocks, which can be measured, e.g., for quantum yield, radiation hardness, etc., and further optimized. Luminescent building blocks have been synthesized with ultrafast decay lifetime for a scintillator.

Although example detector elements are described herein for improving ToF-PET for illustration of example features and benefits, example 3D printing methods can be used for other suitable applications, such as, but not limited to creating novel nanophotonic devices for new biosensors, or for practical methods to build improved communications and optical computing devices.

Example detectors herein can be provided by fabricating structures of scintillating nanoparticles (NP) and structures of conducting or plasmonic material, such as but not limited to metal (generally, conducting structures). Automated layer-by-layer deposition of NPs as building blocks of metamaterials can be provided in example fabrication methods by, for instance, upscaling methods for NP self-assembly and 3D superlattice structures, e.g., see E. V. Shevchenko, D. V. Talapin, N. A. Kotov, S. O'Brien, and C. B. Murray, “Structural diversity in binary nanoparticle superlattices,” Nature, vol. 439, no. 7072, pp. 55-59, January 2006. Scalable approaches can be provided for building sufficiently-sized PET detectors.

Nanoparticles (NPs) can be used as building blocks of example metamaterial scintillation materials, analogous to the way that small molecules are used in atomic layer deposition (ALD) processes to build thin films layer-by-layer. Example methods provided herein can be employed, for instance, for the fabrication of scintillating nanoparticles (ScNPs) with BGO. An example method to synthesize BGO NPs is disclosed in M. J. Oviedo et al., “New Bismuth Germanate Oxide Nanoparticle Material for Biolabel Applications in Medicine,” Journal of Nanomaterials, 2016. BGO is an excellent material for an example metamaterial scintillator for which decay rate and light yield can be strongly enhanced by the Purcell effect. Other example methods are provided herein.

In addition to BGO, novel fluoride-based luminescence materials may be used for NPs, including, as described above, alkaline-earth rare-earth fluoride (MLnF, where ‘M’ is an alkaline-earth element such as Li, Na, Ca, Sr, or Ba, and ‘Ln’ is trivalent rare-earth ions (lanthanoid element)). Example raw materials for Purcell enhanced metamaterials include but are not limited to Bismuth, germanium, lutetium, lanthanum, and others. MLnF scintillation NPs (ScNPs) can be provided for creating example high-performance scintillators due to their high density and fast (optical-frequency) decay times (<1 ns), cubical shape for high packing fraction, and good stability, as the example MLnF NPs do not degrade over time from oxidation or humidity.

An illustrative example MLnF material for NPs is BaLuF. To provide example BaLuF NPs, BaF₂ may be alloyed with LuF₃ to increase effective Z and density. Lu (Lutetium) is the highest Z lanthanide and is used in PET scintillators (e.g., LSO). BaLuF NPs can be doped with other lanthanide ions, either as alloys or as dopants, to form luminescent centers, to shift the emission to the visible and to optimize decay time and light yield. In addition, BaLuF may be alloyed with other alkaline-earth elements, such as Ca or Sr, to further tune the material properties. For LSO, alloying with small amounts of Ca enhances the luminescent properties by depopulating shallow traps. Example ScNPs can be synthesized using methods beyond traditional crystal growth methods. Encasing the NPs in a shell can increase upconversion quantum yield (UCQY) in particle systems, e.g., as disclosed in A. Lay et al., “Bright, Mechanosensitive Upconversion with Cubic-Phase Heteroepitaxial Core-Shell Nanoparticles,” Nano Lett., vol. 18, no. 7, pp. 4454-4459 July 2018, and provide an additional control on scintillation from the NP.

The deploying of example ScNPs can provide a new materials toolkit for PET scintillators. Example fabrication methods can use colloidal design, synthesis, and/or characterization techniques, including those provided herein, to synthesize particles of various morphologies, including spheres, cubes, and rods, as well as variations in stoichiometry, alloying, and doping to achieve a range of desired optical properties.

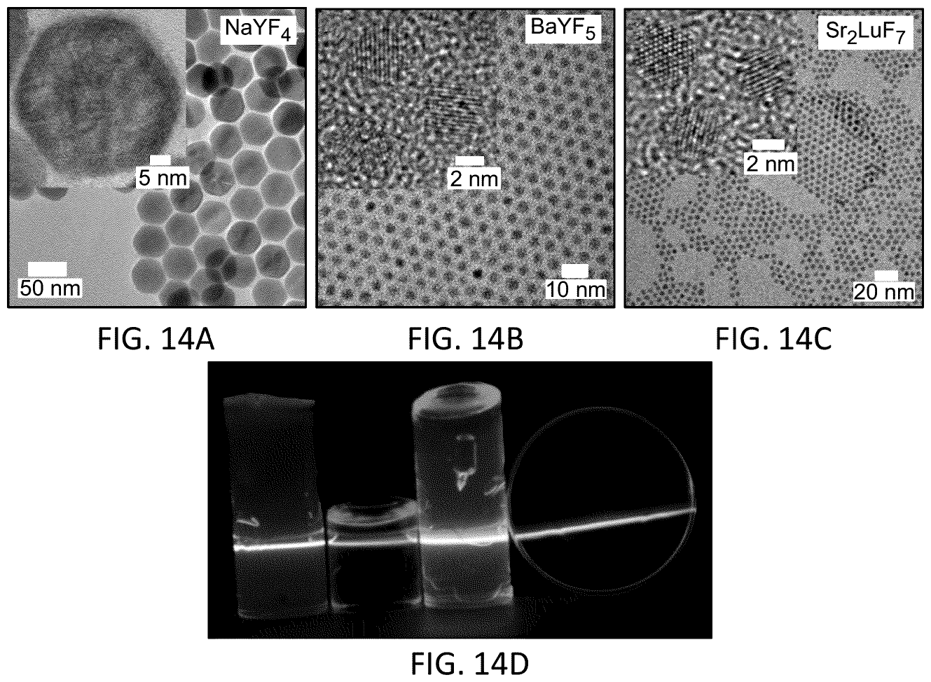

FIG. 14 shows a selection of example scintillating NPs, in which high-quality monodisperse fluoride nanoparticles are synthesized with controlled composition, size, and shape. Example scintillating materials can be similar to BGO and LSO in many respects but can provide higher visible light yield due to lower phonon energies and lower non-radiative losses. The NPs can be surface-functionalized to make them dispersible in and embedded in various host matrices, e.g., as shown by example in FIG. 14 (d). FIG. 14 (e) illustrates example complex core/shell structures that can be synthesized to tailor the nanoparticle properties for optimized configurations, such as but not limited to PET detector configurations.

NP properties may be tuned via doping, by size, by shape, or by core/shell or multi-shell approaches. The emission yield and decay time of the NPs can be widely tuned. For example, doping the NPs with active lanthanide ions can tune the emission spectrum, photon yield, and time response. FIG. 7D shows example color tunability achieved by doping NaYF₄ NPs with lanthanide ions. The lanthanide-doped NPs were excited by a 980 nm NIR laser, which act as upconverters of the NIR light. Under X-ray excitation the lanthanide emissions occur at the same positions as photon excitation.

Example NPs can be synthesized using a colloidal (wet chemical) synthesis, enabling multi-gram-scale NP synthesis. Colloidal synthesis can be employed, for instance, in a cost-efficient and scalable (multigram) approach. In other examples, standard thin film production techniques, such as spin coating, can be used for Purcell enhanced metamaterial production. In some example embodiments, the NPs are synthesized using a (wet chemical) standard “Schlenk” line setup.

Purcell enhanced metamaterial designs may be configured and/or optimized to enhance the scintillator decay rate, among other enhancements. For instance, a range of NP sizes and shapes can be provided to optimize for light output, high photoelectron and Compton scattering cross section with high effective Z and density, and fast rise and decay time for good coincidence timing for advancing ToF-PET. Example scintillators herein can also be configured to alter the generation of scintillation photons in the near ultraviolet (NUV) to visible (Vis) range of the spectrum.

The NP properties may be configured to optimize the example PET-detector. Example methods provided herein can be used to synthesize, characterize (e.g., structural, optical, etc.), and build a database or library of mono dispersed lanthanide doped core-shell nanoparticles and to identify optimal compositions, such as but not limited to scintillators offering high Z and sub ˜20 ns decay lifetime in UV regime. As a nonlimiting example, a library of colloidal MLnF nanocubes can be synthesized, and X-ray excited scintillation dynamics in the UV-Vis regime can be evaluated.

As provided herein, methods such as transmission electron microscopy (TEM), X-ray diffraction (XRD), and chemical analysis methods can be used to characterize properties of ScNPs. TEM, for instance, can be used to measure the size and morphology of the NPs. XRD and chemical analysis methods can be used to verify the chemical and structural composition of the NPs. An example characterization method characterizes the ScNPs using a 50 fs pulsed X-ray source and a 266 nm UV source. The resulting scintillation light yield, rise time, decay time and emission spectra can be measured by, for instance, a fast photomultiplier tube (PMT) and microchannel plate PMT and a spectrometer with the results compared to conventional scintillation crystals. Stability of the ScNPs can be evaluated by measuring the properties over time.

In an example method for configuring or optimizing scintillation materials, metamaterial NP superlattices (NPs arranged in a periodic array) can be simulated and combinations of metallic NPs and ScNPs can be investigated to characterize scintillation NP properties and accordingly select properties that can provide an optimal CTR. Variations are possible, for instance, for the NP size, material, inter-particle separation, and/or superlattice unit cell (e.g., hexagonal close-packed, cubic, etc.).

As described herein, the metallic NPs can enhance the emission of the scintillating NPs by locally concentrating EM fields and increasing the Purcell factor (increase in radiative power of the scintillator). In some example metallic NPs, Al or Ag can be provided in shells encasing a ScNP such as shown in FIG. 13, or as a NP in a binary superlattice (with alternating layers of metallic NPs and ScNPs), such as shown by example in FIG. 12, to enable highest Purcell enhancements at peak scintillation wavelengths.

An example metamaterial can be configured, e.g., using full-field EM calculations and simulations to optimize Purcell enhancement. In example methods, a processor (executing code) can be provided to analytically solve for the electromagnetic fields within a variety of metamaterials. For example, H. Alaeian and J. A. Dionne, “OSA/Plasmon nanoparticle superlattices as optical-frequency magnetic metamaterials.” https://www.osapublishing.org/oe/abstract.cfm?uri=oe-20-14-15781, 2019, discloses use of rigorous coupled wave analysis (RCWA) to analyze the electromagnetic field distributions in a variety of periodic media, including plasmonic particle arrays and metal-dielectric nanocrystal superlattices. Calculations can be complemented with, for instance, a commercial EM simulation program, an example of which is known as LUMERICAL™.

Example calculations, such as disclosed in C. Atre, A. García-Etxarri, H. Alaeian, and J. A. Dionne, “Toward high-efficiency solar upconversion with plasmonic nanostructures,” J. Opt., vol. 14, no. 2, p. 024008, January 2012, when applied to BGO-like nanocrystals with a metallic crescent shell, similar to that seen in FIG. 13, indicate that example metamaterials can significantly enhance the decay rate and quantum yield of an emitter for scintillation. A ˜100-1000× enhancement from an emitter, for instance, can be obtained at various wavelengths, e.g., at one or more peaks within an example range of 500-800 nm, and the wavelengths with the largest enhancement(s) can be tuned with the crescent dimensions. The emission enhancement is largely independent of the angle (0, 90, 180) of the crescent, which is useful for large-area superlattice fabrication.

Example metamaterials can be provided that substantially decrease the decay time, e.g., by >100×, and increase the light yield of a scintillator (e.g., by >100×). This can improve the photostatistics and reduce the time variability (jitter) of the rising edge of the pulse, which improves CTR. The metamaterial can modify an emitter's radiative decay rate via the Purcell effect, increasing light emission and reducing decay time. It has been demonstrated that plasmonic structures can decrease the radiative decay time by 1000×. An ScNP-based metamaterial design can be configured or optimized to enhance the scintillation light yield and reduce the decay time.

Example metamaterials can exhibit a higher refractive index than known inorganic scintillators, providing a secondary benefit of increased CR yield compared to that emitted from standard monocrystal BGO. A high index of refraction can also promote total internal reflection (TIR) to help improve the light collection efficiency into a photodetector coupled to the crystal. Example simulations can be used to calculate and optimize the transmittance as a function of wavelength of the metamaterial.

For illustration, example methods for forming a superlattice structure providing a metamaterial detector, such as but not limited to 3×3×20 mm³ detector elements, will now be described. In an example method for 3D-printing NPs, a multistep pathway for preparing NP ink can be used in direct ink writing (DIW), an extrusion-based 3D printing approach. To prepare the NP ink, a surface functionalization/ligand exchange approach can be used to polymer wrap the NP, resulting in a solvent-free honey-like viscous liquid as a final product, e.g., as disclosed in B. Shao et al., “Engineered Anisotropic Fluids of Rare-Earth Nanomaterials,” Angew. Chem. Int. Ed., vol. 59, no. 41, pp. 18213-18217, 2020, Example NPs may also be encased in a thin silica shell, as disclosed herein. To determine suitability for 3D printing, candidate NPs can be dispersed in a medium with a low dielectric constant at high volume fractions to simulate a photocurable liquid organic resin.

An example fabrication method for a metamaterial can use continuous liquid interface production (CLIP) 3D printing, e.g., as disclosed in J. R. Tumbleston et al., “Continuous liquid interface production of 3D objects,” Science, vol. 347, no. 6228, pp. 1349-1352 March 2015; R. Janusziewicz, J. R. Tumbleston, A. L. Quintanilla, S. J. Mecham, and J. M. DeSimone, “Layerless fabrication with continuous liquid interface production,” Proc. Natl. Acad. Sci., vol. 113, no. 42, pp. 11703-11708, October 2016; and A. R. Johnson et al., “Single-Step Fabrication of Computationally Designed Microneedles by Continuous Liquid Interface Production,” PLOS ONE, vol. 11, no. 9, September 2016. CLIP is capable of rapidly assembling 3D structures at 500 mm/hour. The print speed can be varied by an oscillatory reciprocating print platform to maintain intraparticle packing characteristics. The volume of polymer resin can be adjusted, though it will still reduce the effective density and Z of the material.

Scintillating and metal NPs can be assembled into a monolayer superlattice structure, which structure may be configured, e.g., using simulation, or in other ways. A 3D metamaterial design can be assembled by decorating ScNPs with metal using a self-assembly bottom-up approach such as disclosed in S. N. Sheikholeslami, H. Alaeian, A. L. Koh, and J. A. Dionne, “A Metafluid Exhibiting Strong Optical Magnetism,” Nano Lett., vol. 13, no. 9, pp. 4137-4141 September 2013.

In an example metamaterial structure, the metal NPs can be functionalized with a small number of biotin-terminated polyethylene glycol (PEG) ligands. The (e.g., BGO, MLnF, etc.) NPs can then be coated with streptavidin. The soft ligands can remain as part of the metamaterial to help prevent NP agglomeration and ensure assembly of the metal and scintillating NPs into, for example, a 3×3×20 mm³ superlattice structure with high packing fraction. High density can be achieved, for instance, by using a short ligand length and/or larger NP size. This bottom up approach can also be used to fabricate 2-D superlattices. Additional example features of a superlattice structure are provided in Table 1, below.

Additional formation methods for metamaterial structures may be used as well. In example methods, high effective Z/density metamaterials can be achieved, e.g., using short ligands.

3-D printers can use inks of metallic NPs suspended in encapsulating organic additives to prevent agglomeration. As opposed to the example CLIP method above, the liquid and organic additives may then be removed by a sintering process leaving only the NPs for a high effective density and Z detector element. Self-assembling NPs functionalized with organic ligands have been suspended in tolulene and used to successfully fabricate a large-scale (e.g., millimeters thick) metamaterial, e.g., see B. Domenech et al., “Strong Macroscale Supercrystalline Structures by 3D Printing Combined with Self-Assembly of Ceramic Functionalized Nanoparticles,” Adv. Eng. Mater., vol. 22, no. 7, p. 2000352, 2020.

In addition to a biotin-streptavidin system, other DNA-based methods, such as disclosed in R. J. Macfarlane, B. Lee, M. R. Jones, N. Harris, G. C. Schatz, and C. A. Mirkin, “Nanoparticle superlattice engineering with DNA.,” Science, vol. 334, no. 6053, pp. 204-208, 2011, have been employed for self-assembly of NPs, such as disclosed in Q.-Y. Lin et al., “Building superlattices from individual nanoparticles via template-confined DNA-mediated assembly,” Science, vol. 359, no. 6376, pp. 669-672, February 2018 as well as self-assembly based on NP sedimentation to produce millimeter-scale single crystalline domains, such as disclosed in J. Gong et al., “Shape-dependent ordering of gold nanocrystals into large-scale superlattices,” Nat. Commun., vol. 8, no. 1, pp. 1-9, January 2017.

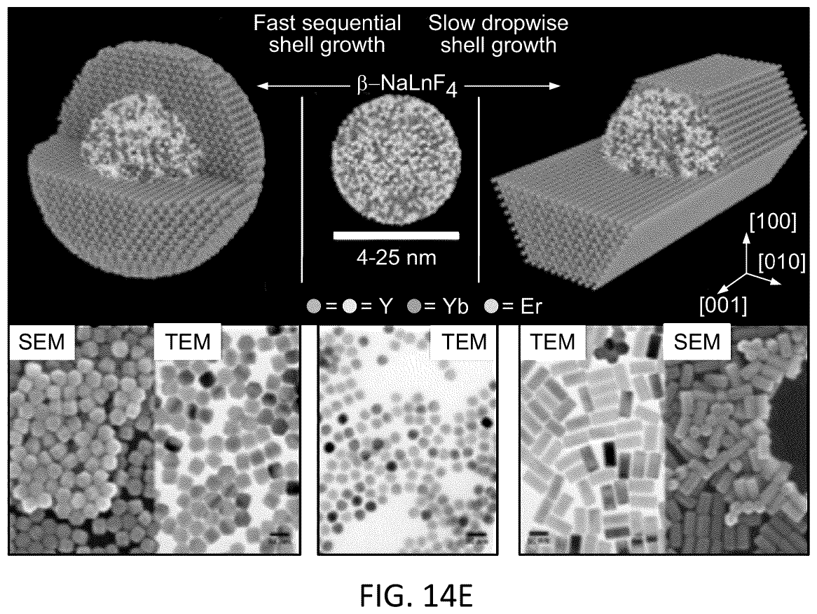

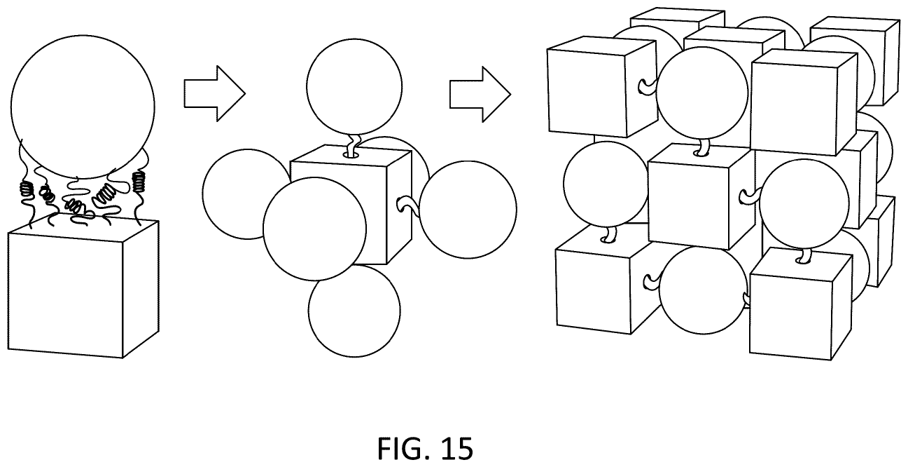

FIG. 15 illustrates an example method for superlattice fabrication through DNA-assisted self-assembly, such as disclosed in Lu, F., Yager, K., Zhang, Y. et al. Superlattices assembled through shape-induced directional binding. Nat Commun 6, 6912 (2015). In this example method, DNA tethers lead cubic blocks and spheres to self-assemble so that one sphere binds to each face of a cube, resulting in a regular, repeating arrangement.

Instead of 3D printing, a Langmuir-Blodgett (LB) trough, e.g., as disclosed in V. A. Bykov, “Langmuir-Blodgett films and nanotechnology,” Biosens. Bioelectron., vol. 11, no. 9, pp. 923-932, January 1996, can be used to fabricate a 3 mm×20 mm×1-5 μm thick element. A monolayer film on a liquid can be prepared and the molecules can be compressed or expanded. The monolayer film can then be applied to a solid substrate and repeated to create multi-layer films.

Akin to atomic (ALD) and molecular layer deposition (MLD) for thin film deposition, nanoparticle layer deposition (NPLD) can be used to make a bulk metamaterial via layer-by-layer assembly, e.g., see Y. Liu, M. G. Williams, T. J. Miller, and A. V. Teplyakov, “Nanoparticle layer deposition for highly controlled multilayer formation based on high-coverage monolayers of nanoparticles,” Thin Solid Films, vol. 598, pp. 16-24, January 2016. The NP layers can be covalently bonded using azide and alkyne functional groups to form a highly stable triazole ring. Many layers of NPs can be precisely placed to assemble the proposed metamaterial crystal in a fully automated “click chemistry” approach.

Hyperbolic metamaterials using two different NPs can be fabricated using commercial RF magnetron sputtering tools, such as disclosed in K. C. Santiago, R. Mundle, C. White, M. Bahoura, and A. K. Pradhan, “Infrared metamaterial by RF magnetron sputtered ZnO/Al:ZnO multilayers,” AIP Adv., vol. 8, no. 3, p. 035011, March 2018. There is a tradeoff between throughput and deposition precision, but an example mm thick metamaterial may be fabricated at high throughput and low cost with a high packing density.

The luminescence properties of the metamaterial can be measured using fast pulsed UV and X-ray sources, e.g., in a nanocharacterization facility. The light yield, rise time, and decay time for the metamaterial can be characterized, for instance, using similar methods as for characterizing the ScNPs.

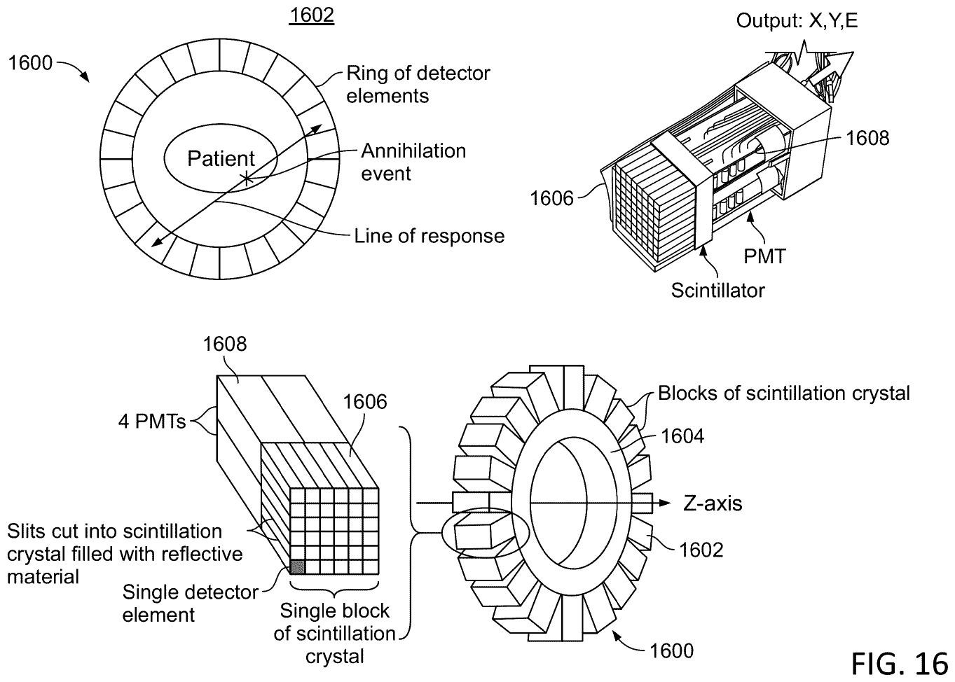

FIG. 16 shows an example PET detector ring 1600 for detecting an annihilation event. The PET detector ring 1600 includes a plurality of scintillation crystal blocks 1602 arranged in a ring surrounding a central core 1604, in which a patient may be disposed. The example scintillation crystal block 1602 includes a single block of scintillation crystal 1606 providing a two-dimensional array of detector elements via slits formed (e.g., cut) into the scintillation crystal filled with reflective material. A two-dimensional array (e.g., 2×2, as shown) of photomultiplier tubes (PMTs) 1608 are coupled to the scintillation crystal.

Side readout of crystals 1602 may be used to reduce optical time dispersion in its path to a photodetector. PET scintillator array crystal elements are typically 3×3×20 mm³ for 3 mm spatial resolution while stopping most 511 keV photons that pass through the crystal. Crystals are typically read out on one of the 3×3 mm² faces. Scintillator light can take many different paths to the photodetector. With a side-readout, the path length variations can be reduced, improving temporal response.

In some example fabrication methods, the index of refraction can also be gradually tapered down at one end of the crystal 1606 to match the photodetector material for better light collection and lower transit time variance. While the Purcell factor and scintillation enhancements may be reduced in this tapered region, this region will be at the end of the crystal that is furthest from incoming photons, where the probability of a scintillation event is lowest, and thus the average enhancement factor for scintillation should still remain high.

An example side readout approach can provide DOI and reduce the scintillation photon transit time variance of 20+mm length crystals to be comparable to that of 5 mm length crystal elements. This side readout approach can also be used in an example metamaterial-based super-scintillator to maintain high 511 keV detection efficiency without increasing scintillation photon transit time variance. Further, example SiPM designs can include time skew correction to further improve SPTR down to 19 ps from 80-100 ps for current commercial SiPMs. For such advances, a metamaterial scintillator that has a decay time of 5 ns and a rise time of 0.5 ps, and an Nₚₑ=62,000 could also attain <10 ps CTR.

The radionuclides used in PET scans are made by, for example, attaching a radioactive atom to chemical substances that are used naturally by the particular organ or tissue during its metabolic process. The most commonly used isotope in PET scans is fluorine-18. It is a fluorine isotope with a half-life of approximately 110 minutes.

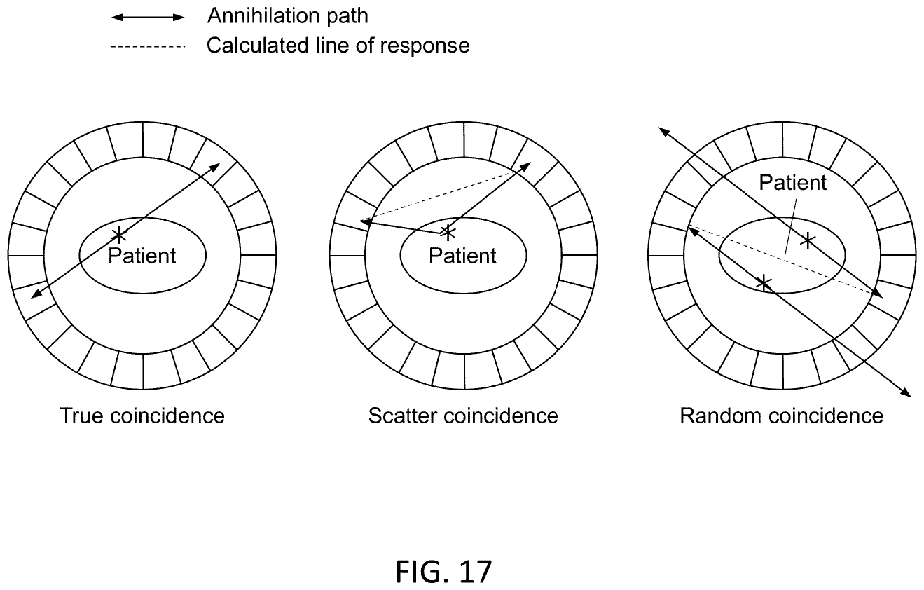

The annihilation event is detected by the detector elements 1606 disposed along an annihilation path. For each such detector element, an output (X, Y, E (energy)) is generated at a particular time from the received photon. Using the output and the time, a processor detects a line of response (LOR) for the annihilation event. For example, as illustrated in FIG. 17, for a true coincidence event, one annihilation is detected including a pair of emitted photons, which form a straight path in opposite directions, and the LOR is calculated along the straight annihilation path. For a scatter coincidence event, there is one annihilation, but the photons scatter. The measured LOR places the annihilation reaction along an artefactual projection. For a random coincidence effect, more than one annihilation is detected such that photons from different annihilations are detected simultaneously. An artefactual LOR is calculated.

As explained above, the CTR of a PET detector can be improved by increasing the luminescence yield and/or by reducing the rise (Tr) and decay (Ta) times. Example metamaterial-based scintillators provided herein can increase light yield and can have faster rise and decay times than the scintillator material itself due to the Purcell effect. Novel metamaterial scintillators having increased luminescence yield, shorter rise time, and shorter decay time, for instance, can be used to enable an improved CTR PET detector to provide, e.g., ˜5×RISNR gain over current ToF-PET systems. Table 1, below, shows properties of example PET detectors with metamaterials compared to Conventional BGO and LSO: Ce.

TABLE 1

| | Metamaterial | | | | | |
|---|---|---|---|---|---|---|
| | BGO* | | BGO** | | LSO*** | |
| Coincidence Time | 10 | ps | 277 | ps | 125 | ps |
| Resolution (CTR) | | | | | | |
| Scintillation Light | ~99,000 | | 8.200 | | 30,000 | |
| Yield (photons/MeV) | | | | | | |
| Detectable Cherenkov Photons | 30-50 | | 20 | | ~0 | |
| Rise Time | 0.3 | ps | 30 | ps | 70 | ps |
| Decay Time | ~3 | ns | 300 | ns | 40 | ns |

| | | | |
|---|---|---|---|
| Effective Z**** | >68 | 74 | 66 |
| Effective density (g/cm³)**** | ~6 | 7.1 | 7.4 |
| Detector element | 3 × 3 × 20 | 3 × 3 × 20 | 3 × 3 × 20 |
| volume (mm³) | | | |
| Refractive Index | >3 | 2.3 | 1.8 |

In Table 1,
*denotes optimal features of an example metamaterial created from BGO nanoparticles and AI nanoparticles,
**denotes best in lab using Cherenkov light from standard BGO scintillator, as disclosed in J. W. Cates and C. S. Levin, “Electronics method to advance the coincidence time resolution with bismuth germanate,” Phys. Med. Biol., vol. 64, no. 17, p. 175016, September 2019,
***denotes best in lab for LSO scintillator as disclosed in J. W. Cates and C. S. Levin, “Advances in coincidence time resolution for PET,” Phys. Med. Biol., vol. 61, no. 6, p. 2255, 2016, and
****denotes an assumption that the metamaterial uses BGO and Al (compositing with AI lowers the effective Z and density of the BGO-based metamaterial).

In Table 1, * denotes optimal features of an example metamaterial created from BGO nanoparticles and Al nanoparticles, ** denotes best in lab using Cherenkov light from standard BGO scintillator, as disclosed in J. W. Cates and C. S. Levin, “Electronics method to advance the coincidence time resolution with bismuth germanate,” Phys. Med. Biol., vol. 64, no. 17, p. 175016, September 2019, *** denotes best in lab for LSO scintillator as disclosed in J. W. Cates and C. S. Levin, “Advances in coincidence time resolution for PET,” Phys. Med. Biol., vol. 61, no. 6, p. 2255, 2016, and **** denotes an assumption that the metamaterial uses BGO and Al (compositing with Al lowers the effective Z and density of the BGO-based metamaterial).

For an example metamaterial attaining the parameters of Table 1, then τ_{d}=1/100τ_{d(BGO)}n τᵣ=1/100τᵣ₍₈₆₀₎ and Nₚₑ=12.07N_{BGO}. Assuming the same rise time, then CTR=\sqrt{τᵣτ_{d}/Nₚₑ}=(1/100)\sqrt{τ_{r(BGO)}τ_{d(BGo)}/12.07N_{BGO}}=0.00288CTR_{BGO}. For BGO, 1.9 ns CTR has been measured previously, and CTR is estimated to be roughly 6 ps for an example metamaterial. For example, using the Ag crescent nanostructure of FIG. 13 and the refractive index of BGO (n˜2.3), simulations indicate a spatial average of the Purcell enhancement FP of 100; such an increased radiative rate can produce a light yield of 99,000 photons per MeV.

A metamaterial scintillator configured as in Table 1 can achieve a CTR that is 24× lower than a comparable LSO detector. Using an existing photodetector and crystal geometry that attains 214 ps CTR in a commercial system, for instance, would result in a <10 ps CTR detector.

FIG. 13D shows a plot of reconstructed image signal to noise ratio (RISNR) versus coincidence time resolution (CTR) (ps) for example 20, 30, and 40 cm diameter cylinders. The most advanced ToF-PET system currently available achieves a best result of 214 picosecond (ps) CTR, providing ˜2.5×RISNR gain over non-ToF-PET in a typical patient. Compared to a ToF-PET system with 214 ps CTR, providing a 10 ps CTR can result in an additional 4.6×RISNR improvement, or a 21× lower injected radionuclide dose for the same scan time or 21× shorter scan time for the same dose. Such a nearly 5-fold RISNR boost can provide more accurate detection, visualization, and quantification of various diseases (e.g., heart disease, neurological disorders, and cancer) and their recurrence.

Current detector technology has a CTR on the order of 100-200 ps. To achieve low, such as but not limited to <10 ps, CTR in an example PET detector, example methods can estimate the arrival time from both scintillation light and complete response (CR).

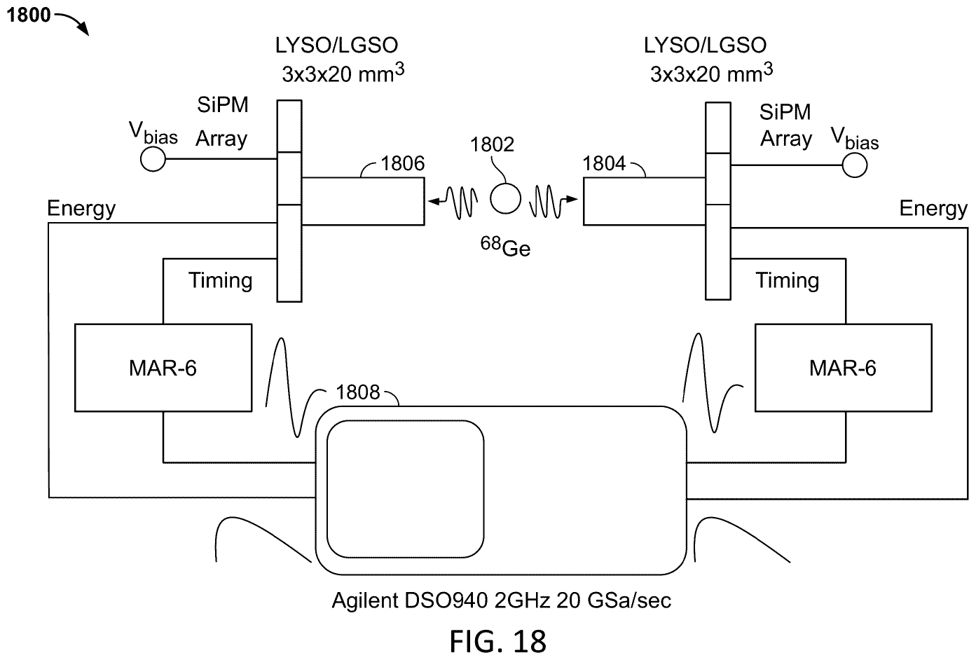

The CTR of two metamaterial detectors in coincidence can also be measured using a positron emitting isotope such as Na-22 or Ge-68 and rise times can be calculated using the measured CTR, τ_{d}, and Nₚₑ using CTR=A\sqrt{τᵣτ_{d}/Nₚₑ}. An example setup 1800 is shown in FIG. 18 to measure energy resolution and CTR of a test crystal. A Ge-68 source 1802 is placed between crystals 1804 coupled to photosensors or photodetectors 1806, such as but not limited to silicon photomultipliers (SiPM). A digital oscilloscope 1808 measures the differential arrival time and energy of the annihilation photons at both crystals. For CR, ultra-violet (UV) photodetectors have been shown to improve CTR. Other example silicon photomultipliers may include near-UV (300-400 nm) sensitive NUV-HD SiPM and RGB-HD SiPM. Photosensors or photodetectors other than photomultipliers may be used as well.

The transmittance of the metamaterial can further be measured with a visible-NUV laser source to assess defects in the material that can degrade the transparency. Effects of tapering the index of refraction can be measured by comparing the CTR for a photodetector coupled to the tapered end and the untapered end.

To tune the emission to the UV-Vis regime and optimize the luminescence yield, an example formation method synthesizes monodisperse, sub 20 nm diameter MLnF core-shell nanoparticles doped with high Z trivalent lanthanides (Ce³⁺, Pr³⁺) with fast spontaneous emission rate and concentrations systematically varying from 5%-45%. SrLuF with an effective Z of 54.5 provides an example host lattice. To reduce surface quenching, example nanoparticles are shelled with undoped SrLuF as an inert shell. Example core-shell nanoparticles achieved a fast decay lifetime of sub ˜18 ns for 25% Ce3+ doped SrLuF host lattice in experiments.

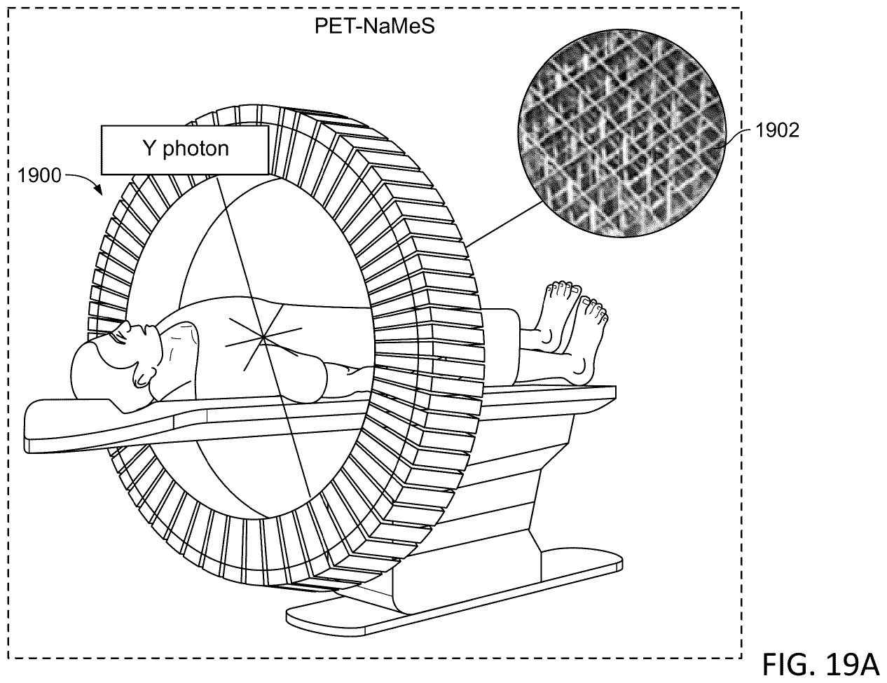

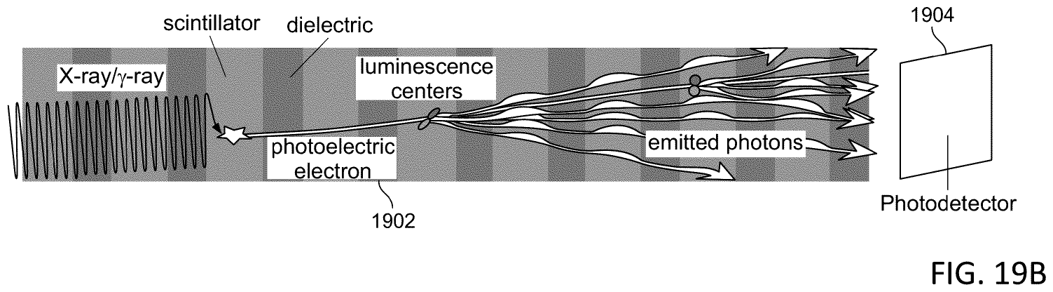

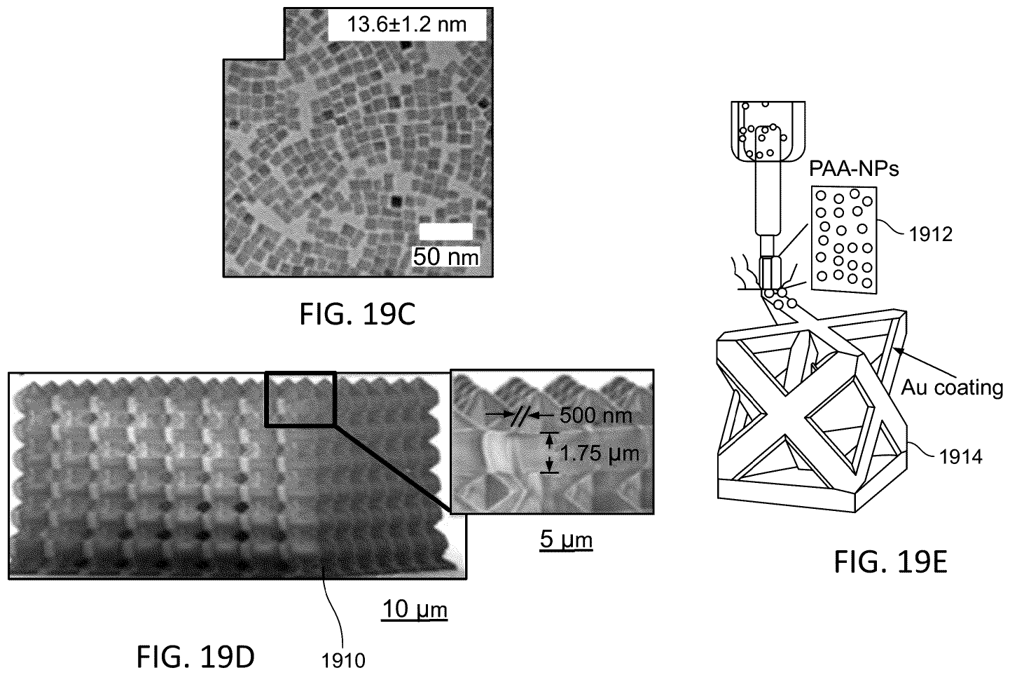

FIGS. 19A-19E show another example 3D superlattice-based PET system 1900 with nanophotonic metamaterials scintillators 1902 (referred to as PET-NaMeS) having Lanthanide doped nanoparticles. The example PET system incorporates a 3D superlattice metamaterial design for the scintillators 1902, such as provided via example fabrication methods disclosed herein, using scintillating alkaline-earth rare-earth fluoride nanoparticles (MLnF) and plasmonic nanoparticles (NPs) as building blocks that are repeated over a mm-cm length scale to provide novel PET detectors for low-dose, high-resolution imaging.

FIG. 19A shows an example detector ring having PET detectors 1900 incorporating 3D superlattice nanophotonic structures. FIG. 19B shows an interior of an example PET detector, including alternating scintillator and dielectric structures, which receives a high energy photon (e.g., X-ray, gamma ray) and produced emitted photons that are detected by a coupled photodetector 1904. FIGS. 19C-19D shows example metamaterial structures 1920. FIG. 19E shows an example method for preparing a superlattice structure 1910 for an example detector 1902, including application of nanoparticle ink 1912 to a coated structure 1914.

In ToF-PET, the measured arrival time difference of the detected 511 keV annihilation photon pair resulting from each detected positron decay localizes the emission origin along each line of response (LoR), e.g., as illustrated in FIG. 17), boosting the effective RISNR by √(D/Δx), where D is the patient thickness along a given LoR and Δx is the position uncertainty (proportional to CTR). For example, for a 40 cm diameter object and 214 ps CTR, the RISNR gain is 2.5 compared to non-TOF PET. For a 10 ps CTR, for instance, there is an additional 4.6× increase in RISNR over 214 ps CTR, which is not possible with current scintillation detector technology.

A novel metamaterial scintillator according to an example embodiment can provide improved (up to 21× better) CTR compared to current PET systems, greatly improving lesion detectability and quantification, lowering injected dose or scan time, and/or potentially enabling new real-time imaging roles for ToF-PET, or lower cost scanner geometries. RISNR gain as a function of CTR for different diameter cylindrical phantoms filled with PET tracer has been evaluated, for instance, in P. Lecoq, “Pushing the Limits in Time-of-Flight PET Imaging,” IEEE Trans. Radiat. Plasma Med. Sci., vol. 1, no. 6, pp. 473-485, November 2017. A potential RISNR gain from 10 ps CTR is 4.6× or 3×, respectively, compared to 214 ps for state-of-art PET/CT, or 100 ps in current research.

Such improvements can transform clinical PET. For example, the increased RISNR can enable visualization and quantification of smaller lesions, which can enable earlier detection of cancer or its recurrence. Additionally, some or all of the RISNR gain can be exploited to substantially reduce the radioactive dose or scan time. State-of-the-art image quality can be attained by reducing a radioactive dose by, for example, 21× for the same scan time or vice versa. Trade-offs can also be made, such as combining a 4× dose reduction with 2.3× gain in RISNR.

Providing a practical PET detector with improved CTR, e.g., as low as <10 ps CTR, can provide a paradigm shift for PET. This enormous (e.g., 6× or greater) SNR boost relative to current state-of-the-art commercial TOF-PET, for example, can improve imaging resolution, including lesion detectability. Current clinical PET systems offer 5-20 mm resolution from the center to perimeter. At 10 ps CTR, each event is confined to a 1.5 mm region along a system LOR, motivating the use of smaller (e.g., 1.5 mm width) crystals to greatly enhance spatial resolution, boosting lesion detectability and quantification.

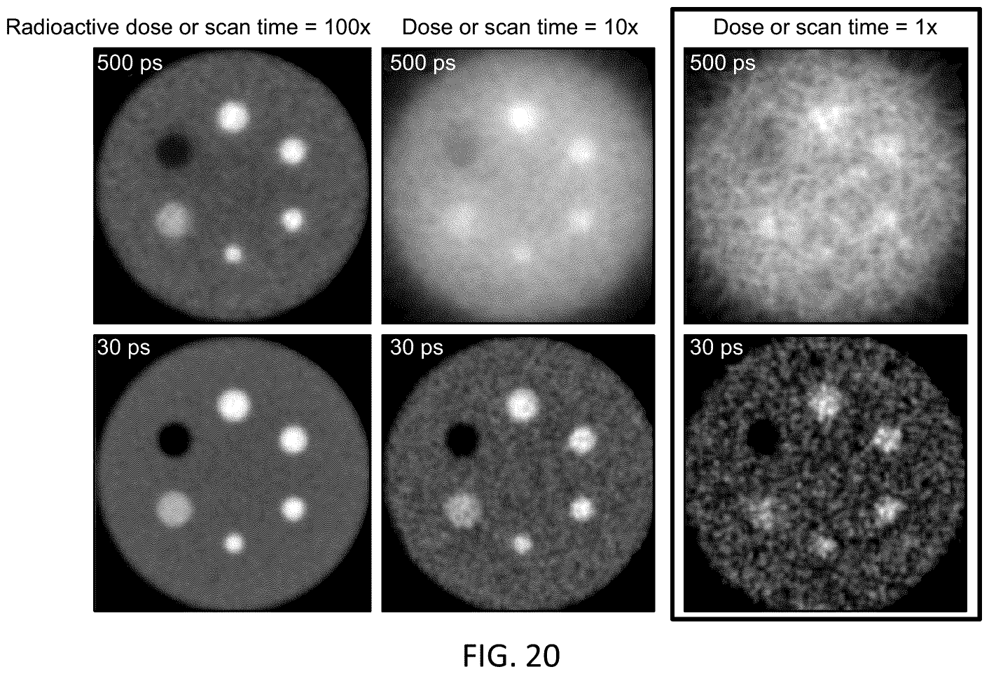

Example image quality gains from improved CTR are shown in FIG. 20. This SNR gain can also be exploited to significantly reduce either patient injected dose or patient scan duration by a substantial factor, depending on CTR (e.g., by 40-fold or more, up to 100-fold for 10 ps CTR). Drastic dose reduction is important for pediatric PET/CT, and 60-70% of the effective dose comes from PET. Such drastic dose reduction can also benefit cancer patients by enabling multiple PET scans to be performed annually in order to monitor the effectiveness of therapies with reasonable radiation exposure.

Example metamaterial detectors can also enable additional new roles for PET. For example, since every positron event would be accurately placed along system response lines, the resulting faster image reconstruction can enable new roles for PET such as but not limited to real-time ‘molecular’ guidance of surgical and radiotherapy procedures, and very short time frame dynamic imaging. Improving PET resolution with high RISNR can also impact the field of radiogenomics. To date, x-ray CT and MR are typically used in radiogenomics due to their higher resolution and RISNR. With improved resolution and RISNR, PET can also be used in more applications.

Other real-time PET applications are possible. For example, PET systems with, non-rotating, “open” geometries such as dual panel PET systems could be used for applications such as molecular-guided surgery or integrated with linear accelerators for molecular-guided radiotherapy without loss of image quality from limited angle tomography artifacts that would be present in a conventional ToF-PET system. Motion correction could be applied, for instance, on a coincidence event by-event basis. With high RISNR, data-based motion correction for lung imaging, for instance, could delineate the lung boundaries in real time or with real-time “optical flow” motion correction methods.

Furthermore, novel lower-cost PET system geometries (e.g., partial ring), and lower overall cost PET system are possible. With 10 ps CTR, tomography may not be needed as each coincidence event could be positioned accurately to one image voxel (e.g., 1.5×1.5×1.5 mm³). This can enable, for instance, new PET system geometries with less crystal volume and simpler mechanical gantries (e.g., two panels instead of a full ring), which can substantially lower costs, assuming a long-term reasonable cost of the metamaterial.

As another example, at the same radioactive dose, the scan time can be reduced from 30 minutes in a typical PET/CT study to 1 minute or less. This could, for example, enable single breath-hold imaging of the lungs for better image quality and accuracy. At the same dose and scan time, the improved statistics can enable higher spatial resolution images to be produced by using higher resolution detectors or resolution recovery (deconvolution) methods.

As a further example, radiogenomics applies deep learning to discover genomic features of cancer from imaging. CT and MR offer high resolution, while PET provides molecular features. Increasing spatial resolution could enrich the PET genomic information.

Additional embodiments herein provide Purcell enhanced metastructures including insertion of metallic nanoparticles to produce Purcell enhancement. In experiments, a simulation study was performed of the plasmonic Purcell effect using the finite-difference time-domain (FDTD) method to show the feasibility of insertion of metallic nanoparticles to produce Purcell enhancement for scintillating nanoparticles. The metallic nanoparticles not only can squeeze the optical mode into a highly confined plasmonic resonance mode but can also minimize the optical loss due to the low volume fraction of lossy metal.

To evaluate alteration of the generation of scintillation photons in the near ultraviolet (NUV) to visible (Vis) range of the spectrum, a metamaterial comprising sub 20 nm scintillating alkaline-earth rare-earth fluoride (MLnF) nanocubes with a width of 30 nm was tested. In an example formation method, core scintillating nanoparticles (spheres with 5 nm radius) were doped with high Z trivalent lanthanide (Ce³⁺) allowing for fast spontaneous emission originating from 4f-5d transitions. Example metamaterials may include, for example, spacing (e.g., up to 5 nm) between nanocubes. A metamaterial nanocomposite including these nanocubes and plasmonic nanorods can be configured to create a super scintillator with Purcell enhanced scintillation properties leading to increased brightness while also reducing the rise and decay time of the scintillation.

To induce the plasmonic resonance coupling to the scintillation process, plasmonic nanoparticles embodied in gold and silver nanorods were used to stimulate the surface plasmon modes in the NUV-Vis frequency range for the scintillation peak. These noble metals also can provide durability owing to their own chemical stability. An example nanorod geometry for the plasmonic nanoparticles is useful because their length can be longer than the effective wavelength of the plasmonic mode to induce plasmonic resonance, while minimizing the conductor volume and the corresponding optical loss.

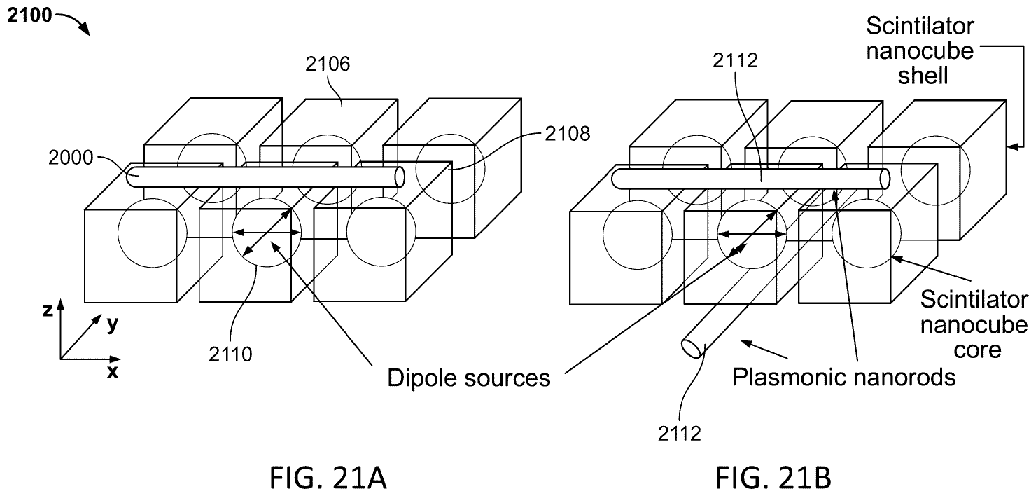

To mimic a low volume fraction of plasmonic metallic nanorods, 1˜2 silver or gold nanorods with an array of SrLuF (effective Z of 54.5) nanocubes were provided in an example simulation. FIG. 21 shows two example nano-rod couplings for a structure 2100 having dipole sources 2104, a scintillator nanocube shell 2106, and a scintillator nanocube core 2108. Each structure further includes plasmonic nanorods including a gold nano-rod 2110 in structure (a), and a (double) silver nanorod 2112 in structure (b).

The Lumerical FDTD™ was used to simulate the plasmonic resonance modes coupled with the dipole source, representing a scintillation photon source. The Purcell factor and emission rate enhancement factor were calculated from the ratio of the electromagnetic emission power of dipole sources to the input power of a dipole source. Assumed were two perfectly synchronized dipole sources with orthogonal polarization to observe polarization-independent results. The input pulse's wavelength range was chosen as the NUV-Vis range (from 300 nm to 700 nm) to simulate the whole wavelength range one might observe from a scintillating nanoparticle.

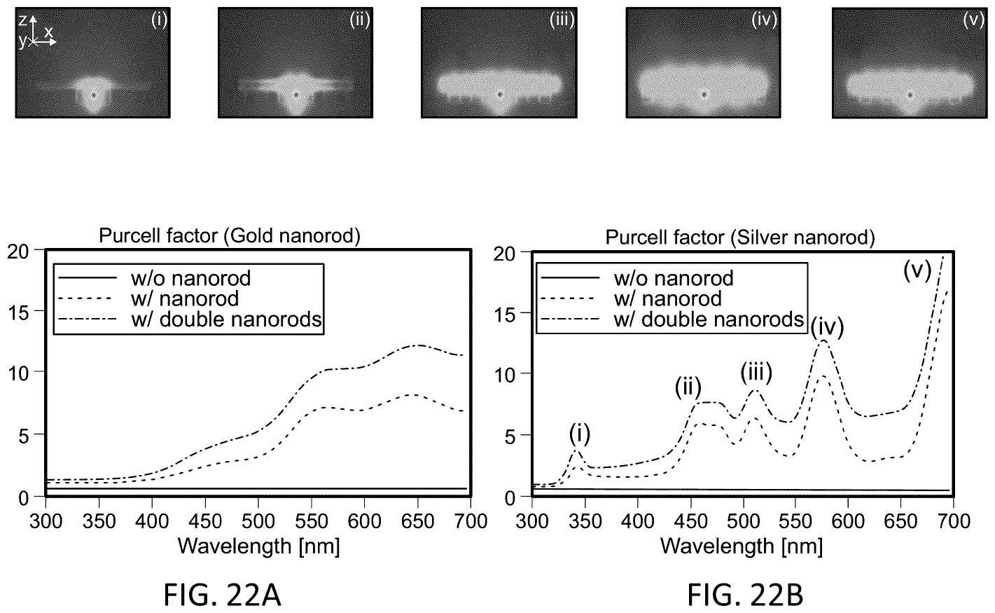

FIG. 22, bottom, shows an example FDTD simulation for the structures (a) and (b), without a nano-rod (lower, flat line), with nano-rod (middle line) and with double nano-rods (upper line). For structure (b), FIG. 22 shows the Purcell enhancement for the example silver nano-rod structure at five mode profiles (wavelengths (i)-(v)). of each peak in the Purcell spectrum.

In the simulation result using FDTD, up to 6.89-fold emission rate enhancement compared to the nanocubes without nanorods was observed in the scintillation band (300-350 nm) at the wavelength of 340 nm. The maximum Purcell factor in this range was 3.78 with Ag nanorods with a 5 nm radius and 350 nm length (the Purcell factor w/o the nanorod in the same condition was 0.55). For the double Ag nanorods (FIG. 21, (b)), the scintillating nanocubes were sandwiched between Ag nanorods, which were aligned on the x- and y-axis to minimize the intersection projected to the light propagation direction (z-axis), respectively.

Such an example configuration was demonstrated to maximize Purcell enhancement, yet lower optical loss due to minimized plasmonic mode volume. The Purcell factor for the example double Ag nanorod configuration was 1.55 times larger than for the single Ag nanorod configuration (Purcell factor of 2.44) at 340 nm. During an example fabrication, the nanorods can be randomly distributed into the regular lattice of nanocubes. It was assumed that the double nanorods configuration would give maximum Purcell factor due to the smallest implementable plasmonic mode volume. Thus, the Purcell factors were expected to vary between the Purcell factor of the single nanorod and double nanorods configurations.

In the Vis regime with longer wavelength (−675 nm), Purcell factors over 20 were observed, though this was mainly caused by the dependency on the cubic square of effective wavelength and would not produce enhancement at the wavelength of the scintillation emissions. In this regime, the peak values in the Purcell factor spectrum originated from the plasmon resonance modes with a longer effective wavelength. The plasmonic resonance modes in the scintillation band had shorter effective wavelengths and were highly confined around the emitting core.

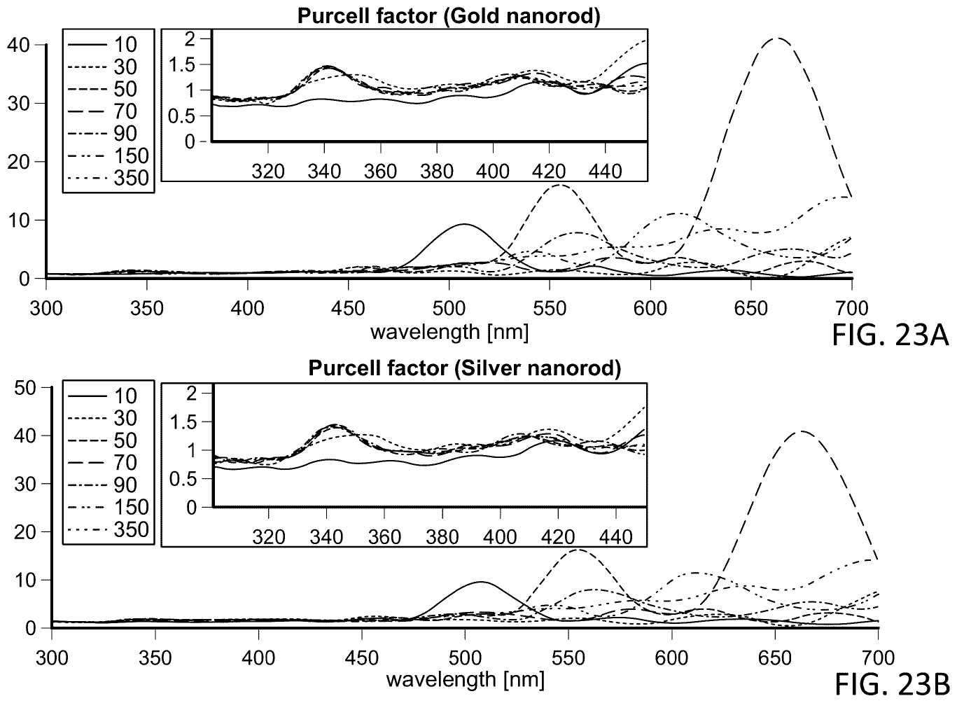

To further evaluate and optimize the nanorod's geometrical dimensions, the Purcell effect was simulated in the metallic nanorod-scintillating nanocube system with varying nanorod lengths (r=2.5 nm). FIG. 23 shows an example enhancement factor, (E/E₀)² as a function of a length of a gold nano-rod (a) and of a silver nanorod (b), illustrating an amount of optical resonance mode coupling efficiency and the corresponding Purcell effect. The inset shows the zoomed spectrum in wavelength range from 300 nm to 450 nm. In FIG. 23, nanorods with a length shorter than 30 nm showed weak Purcell factors around 340 nm, while the Ag and Au nanorods with lengths longer than 50 nm show similar peak values around 340 nm.

The silver nanorods provided a bigger Purcell factor than gold nanorods, though the gold nanorods showed a smoother spectrum and smaller Purcell factor than silver nanorods due to the high optical loss caused by the interband transition of gold in NUV regime. The higher Purcell factor of silver nanoparticles may be due to the better suitability of silver as a plasmonic material in the shorter wavelength range since it better matches that of the scintillation emissions.

Various geometrical nanostructures of plasmonic nanoparticles are possible, including nanospheres, nanocubes, nanocubes, nanorods, nanostars, and nanoellipsoids. Also, other nanorod materials such as aluminum, silver, gold, platinum, magnesium, and tungsten to induce plasmonic resonance in the UV range are possible. Additionally, different shapes of the scintillating nanocrystals are possible.

Other example scintillating metamaterials can be fabricated using photopolymerization methods, an example of which will now be described. The photopolymerization implies transformation of a liquid mix of a photopolymerizable monomer or cross-linked polymer and a photoinitiator (a photocurable composition (PCC)) into a solid material under light irradiation.

Upconversion nanoparticles (UCNPs) composed by NaYF₄ ceramic host doped with Yb³⁺ as a sensitizer, and Er³⁺ or Tm³⁺ as activator are considered to be one of the most efficient anti-Stokes photoluminescent materials. The nanoparticles demonstrate upconversion emission with narrow lines in UV and visible spectral ranges under continuous-wave (CW) excitation at 970-980 nm. Additionally, these nanoparticles combine a large anti-Stokes shift of several hundred nanometers, non-photoblinking nature, and superior photostability.

Reduction of the lifetime of fluorescence has been observed from lanthanide-doped upconversion nanoparticles. The reduced decay time (faster rate) of plasmonic resonances can reduce the lifetime of the ensemble cascade processes leading to scintillation photon generation and consequently enhance the CTR of a PET detector that employs such a metamaterial scintillator.

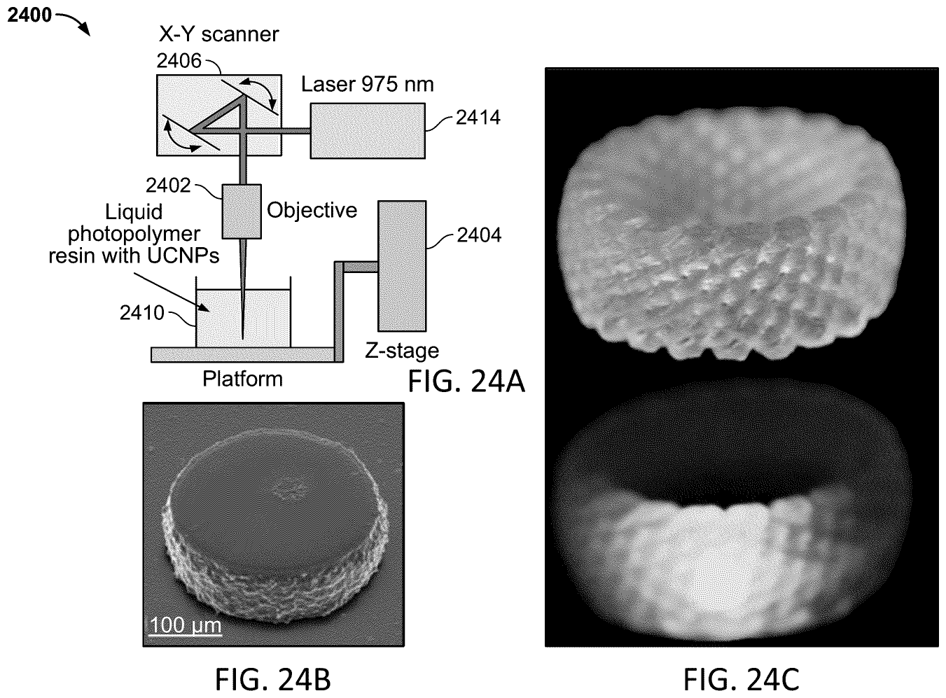

FIG. 24A-24C illustrates an example NIR-light-activated photopolymerization mediated by upconversion emission, e.g., as disclosed in Rocheva, V. V., Koroleva, A. V., Savelyev, A. G. et al. High-resolution 3D photopolymerization assisted by upconversion nanoparticles for rapid prototyping applications. Sci Rep 8, 3663 (2018), as well as an example 3D printing (photopolymerization) of resin composites doped with upconversion nanoparticles. Upconverted photons can efficiently activate photoinitiators contained in light-sensitive resins under moderate intensities of NIR excitation below 10 W cm⁻² and induce generation of radicals and photopolymerizatin in situ. The example system may be used to print with triplet fusion upconversion nanoparticles (TFUC).

An example photopolymerization system 2400 (FIG. 24A) uses a 20 mm focal length lens with a 50× objective 2402, and an xyz stage 2404, 2406 to align a cuvette 2410 to the focal point. The example fused deposition modeling (FDM) printing setup moves a laser spot in three dimensions. The print occurs where the light, e.g., from laser 2414, is most focused, due to TFUC's quadratic dependence on light intensity. The example fabrication method provides 3D rapid production based on NIR light-induced polymerization of photocurable compositions containing upconversion nanomaterials.

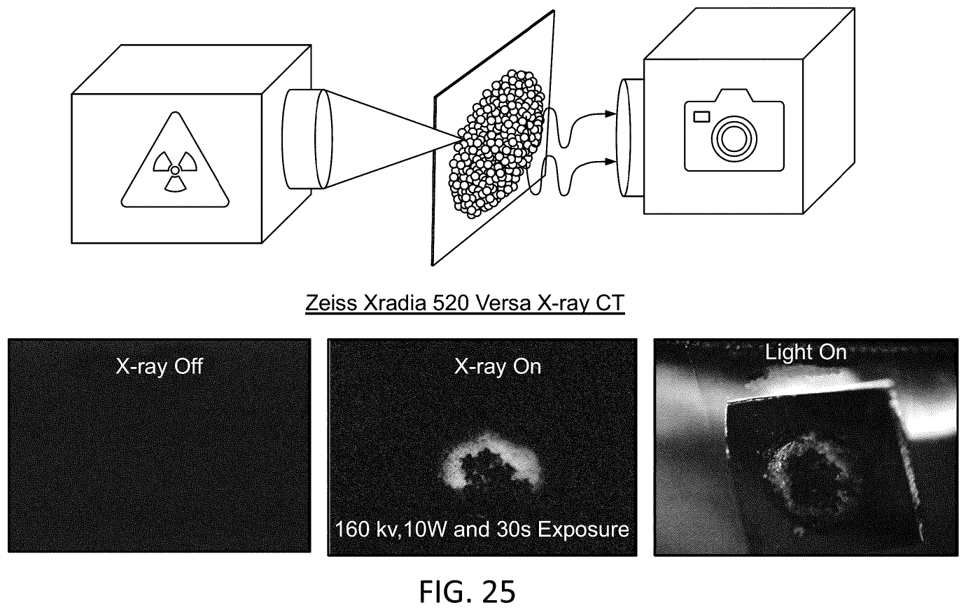

FIG. 25 shows an example X-ray imaging using an X-ray CT-scanner as an excitation source to image the scintillation light emitted from drop-casted MLnF nanostructures (65% Ce dopants) on a silicon substrate. The scintillation light is visible by comparing the X-ray off and on images.

Example embodiments herein provide, among other things, a Purcell enhanced metamaterial scintillator structure comprising: a conducting structure; and a dielectric structure disposed adjacent to the conducting structure; wherein the dielectric structure comprises a structure of scintillating nanoparticles.

In an example Purcell enhanced metamaterial scintillator structure, in addition to any of the above features, the conducting structure and/or the dielectric structure may each be subwavelength (i.e., wavelength of luminescence) in thickness.

In an example Purcell enhanced metamaterial scintillator structure, in addition to any of the above features, the conducting structure and/or the dielectric structure may be greater in thickness than a wavelength of luminescence.

In an example Purcell enhanced metamaterial scintillator structure, in addition to any of the above features, the conductive structure may comprise a conductive layer.

In an example Purcell enhanced metamaterial scintillator structure, in addition to any of the above features, the dielectric structure may comprise a dielectric layer.

In an example Purcell enhanced metamaterial scintillator structure, in addition to any of the above features, the conductive structure may comprise a conductive layer, and the dielectric structure may comprise a dielectric layer.

In an example Purcell enhanced metamaterial scintillator structure, in addition to any of the above features, the metamaterial scintillator structure may comprise one or more unit cells, and each unit cell may comprise the conductive structure and the dielectric structure.

In an example Purcell enhanced metamaterial scintillator structure, in addition to any of the above features, the conductive structure and the dielectric structures may be alternating structures.

In an example Purcell enhanced metamaterial scintillator structure, in addition to any of the above features, the conductive structure and the dielectric structures may be planar structures.

In an example Purcell enhanced metamaterial scintillator structure, in addition to any of the above features, the Purcell enhanced metamaterial scintillator structure may include one or more resonance cavities to provide increased radiative states and/or an increased local density of optical states.

In an example Purcell enhanced metamaterial scintillator structure, in addition to any of the above features, the scintillating nanoparticles may be synthesized from a an alkaline-earth rare-earth fluoride material.

In an example Purcell enhanced metamaterial scintillator structure, in addition to any of the above features, the scintillating nanoparticles may be made from a luminescing material.

In an example Purcell enhanced metamaterial scintillator structure, in addition to any of the above features, the scintillating nanoparticles may be embedded in a host matrix, and the dielectric structure may comprise a thin film.

In an example Purcell enhanced metamaterial scintillator structure, in addition to any of the above features, the scintillating nanoparticles may be doped with active lanthanide ions.

In an example Purcell enhanced metamaterial scintillator structure, in addition to any of the above features, the scintillating nanoparticles may experience plasmon resonances in conductive (e.g., metallic) nanoparticles or shells.

In an example Purcell enhanced metamaterial scintillator structure, in addition to any of the above features, the scintillating nanoparticles may comprise high-refractive nanoparticles.

In an example Purcell enhanced metamaterial scintillator structure, in addition to any of the above features, the conducting structure may comprise a metal.

In an example Purcell enhanced metamaterial scintillator structure, in addition to any of the above features, the dielectric structures and/or the conductive structures may be 3D printed.

In an example Purcell enhanced metamaterial scintillator structure, in addition to any of the above features, the dielectric structures and/or the conductive structures may be self-assembled.

In an example Purcell enhanced metamaterial scintillator structure, in addition to any of the above features, metamaterials may enhance the prompt component of luminescence, e.g., including the Cherenkov radiation portion of the prompt emissions.

Additional example embodiments provide a detector of emitted photons comprising: a Purcell enhanced metamaterial scintillator structure according to any of the above; and a photosensor configured to receive scintillation light from the metamaterial scintillator structure in response to the metamaterial scintillator structure receiving photons emitted from a patient and to generate timing and energy signals in response.

Additional example embodiments provide an imaging system comprising: a plurality of detectors of emitted photons according to the above; processing electronics configured to receive generated timing and energy signals from a pair of the detectors; and a processor configured to generate an image by processing the generated signals.

In an example imaging system, in addition to any of the above features, the photons emitted from the patient may be 511 keV photons.

In an example imaging system, in addition to any of the above features, the plurality of detectors may have a coincidence time resolution (CTR) of <50 picoseconds (ps).

In an example imaging system, in addition to any of the above features, the plurality of detectors may have a coincidence time resolution (CTR) of <10 picoseconds (ps).

In an example imaging system, in addition to any of the above features, processing the generated signals may use time of flight (ToF) methods.

Additional example embodiments provide a method for forming a Purcell enhanced metamaterial scintillator structure comprising: fabricating scintillating nanoparticles; and forming a conducting structure and a dielectric structure disposed adjacent to the conducting structure.

In an example method for forming a Purcell enhanced metamaterial scintillator structure, in addition to any of the above features, the scintillating nanoparticles may be fabricated from a luminescing material.

In an example method for forming a Purcell enhanced metamaterial scintillator structure, in addition to any of the above features, the conductive structure may comprise a conductive layer.

In an example method for forming a Purcell enhanced metamaterial scintillator structure, in addition to any of the above features, the dielectric structure may comprise a dielectric layer.

In an example method for forming a Purcell enhanced metamaterial scintillator structure, in addition to any of the above features, the conductive structure may comprise a conductive layer, and the dielectric structure may comprise a dielectric layer.

In an example method for forming a Purcell enhanced metamaterial scintillator structure, in addition to any of the above features, said forming a dielectric structure may comprise 3D printing a thin film.

In an example method for forming a Purcell enhanced metamaterial scintillator structure, in addition to any of the above features, said formed dielectric structure may be self-assembled.

In an example method for forming a Purcell enhanced metamaterial scintillator structure, in addition to any of the above features, the conducting structure and the dielectric structure may each be subwavelength in thickness.

In an example method for forming a Purcell enhanced metamaterial scintillator structure, in addition to any of the above features, the conducting structure and/or the dielectric structure may be greater in thickness than a wavelength of luminescence.

In an example method for forming a Purcell enhanced metamaterial scintillator structure, in addition to any of the above features, the conducting structure and/or the dielectric structure comprises one or more nanostructures.

In an example method for forming a Purcell enhanced metamaterial scintillator structure, in addition to any of the above features, the nanostructures comprises one or more of nanospheres, nanocubes, nanorods, nanoellipsoids, or nanostars.

Any of the above aspects and embodiments, including those in the supplemental materials or appendix, can be combined with any other aspect or embodiment as disclosed here in the Summary, Figures and/or Detailed Description sections.

As used in this specification and the claims, the singular forms “a,” “an” and “the” include plural referents unless the context clearly dictates otherwise.

Unless specifically stated or obvious from context, as used herein, the term “or” is understood to be inclusive and covers both “or” and “and”.

Unless specifically stated or obvious from context, as used herein, the term “about” is understood as within a range of normal tolerance in the art, for example within 2 standard deviations of the mean. About can be understood as within 20%, 19%, 18%, 17%, 16%, 15%, 14%, 13%, 12% 11%, 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless specifically stated or obvious from context, as used herein, the terms “substantially all”, “substantially most of”, “substantially all of” or “majority of” encompass at least about 90%, 95%, 97%, 98%, 99% or 99.5%, or more of a referenced amount of a composition.

The entirety of each patent, patent application, publication and document referenced herein, including those in the supplemental materials or appendix, hereby is incorporated by reference. Citation of the above patents, patent applications, publications and documents is not an admission that any of the foregoing is pertinent prior art, nor does it constitute any admission as to the contents or date of these publications or documents. Incorporation by reference of these documents, standing alone, should not be construed as an assertion or admission that any portion of the contents of any document is considered to be essential material for satisfying any national or regional statutory disclosure requirement for patent applications. Notwithstanding, the right is reserved for relying upon any of such documents, where appropriate, for providing material deemed essential to the claimed subject matter by an examining authority or court.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, and yet these modifications and improvements are within the scope and spirit of the invention. The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. Thus, the terms and expressions which have been employed are used as terms of description and not of limitation, equivalents of the features shown and described, or portions thereof, are not excluded, and it is recognized that various modifications are possible within the scope of the invention. Embodiments of the invention are set forth in the following claims.

A number of embodiments of the invention have been described. Nevertheless, it can be understood that various modifications may be made without departing from the spirit and scope of the invention. Accordingly, other embodiments are within the scope of the following claims.

1. A Purcell enhanced metamaterial scintillator structure comprising:
a conducting structure; and
a dielectric structure disposed adjacent to the conducting structure;
wherein the dielectric structure comprises a structure of scintillating nanoparticles.

2. The Purcell enhanced metamaterial scintillator structure of claim 1, wherein the conducting structure and/or the dielectric structure is subwavelength (wavelength of luminescence) in thickness.

3. The Purcell enhanced metamaterial scintillator structure of claim 1, wherein the conducting structure and/or the dielectric structure is greater in thickness than a wavelength of luminescence.

4. The Purcell enhanced metamaterial scintillator structure of claim 1, wherein the metamaterial scintillator structure comprises one or more unit cells, each unit cell comprising the conducting structure and the dielectric structure.

5. The Purcell enhanced metamaterial scintillator structure of claim 4, wherein the conductive structure and the dielectric structure are provided as alternating structures.

6. (canceled)

7. The Purcell enhanced metamaterial scintillator structure of claim 1, wherein the Purcell enhanced metamaterial scintillator structure includes one or more resonance cavities to provide increased radiative states and/or an increased local density of optical states.

8. (canceled)

9. The Purcell enhanced metamaterial scintillator structure of claim 1, wherein the scintillating nanoparticles are made from a luminescing material.

10. The Purcell enhanced metamaterial scintillator structure of claim 1, wherein the scintillating nanoparticles are embedded in a host matrix, and wherein the dielectric structure comprises a thin film.

11. The Purcell enhanced metamaterial scintillator structure of claim 1, wherein the scintillating nanoparticles are doped with active lanthanide ions.

12. The Purcell enhanced metamaterial scintillator structure of claim 1, wherein the scintillating nanoparticles experience plasmon resonances in conductive nanoparticles or shells.

13. The Purcell enhanced metamaterial scintillator structure of claim 1, wherein the scintillating nanoparticles comprise high-refractive nanoparticles.

14. (canceled)

15. (canceled)

16. (canceled)

17. A detector of emitted photons comprising:
a Purcell enhanced metamaterial scintillator structure comprising:
a conducting structure; and
a dielectric structure disposed adjacent to the conducting structure;
wherein the dielectric structure comprises a structure of scintillating nanoparticles; and
a photosensor configured to receive scintillation light from the metamaterial scintillator structure in response to the metamaterial scintillator structure receiving photons emitted from a patient and to generate timing and energy signals in response.

18. The detector of claim 17:
wherein the detector is one of a plurality of detectors in an imaging system;
wherein the imaging system further comprises:
a processing electronics configured to receive generated timing and energy signals from a pair of the detectors; and
a processor configured to generate an image by processing the generated signals.

19. The detector of claim 18, wherein the plurality of detectors has a coincidence time resolution (CTR) of <50 picoseconds (ps), and wherein processing the generated signals uses time of flight (ToF) methods.

20. A method for forming a Purcell enhanced metamaterial scintillator structure comprising:
fabricating scintillating nanoparticles; and
forming a conducting structure and a dielectric structure disposed adjacent to the conducting structure.

21. The method of claim 20, wherein the scintillating nanoparticles are fabricated from a luminescing material.

22. The method of claim 20, wherein the conductive structure comprises a conductive layer and the dielectric structure comprises a dielectric layer.

23. The method of claim 20, wherein said forming a dielectric structure comprises 3D printing a thin film.

24. The method claim 20, wherein said formed dielectric structure is self-assembled.

25. The method of claim 20, wherein the conducting structure and/or the dielectric structure comprises one or more nanostructures; and
wherein the nanostructures comprises one or more of nanospheres, nanocubes, nanorods, nanoellipsoids, or nanostars.

26. (canceled)
